(19) United States
(12) Patent Application Publication
(10) Pub. No.: US 2010/0073258 A1
(43) Pub. Date: Mar. 25, 2010

(54) ANTENNA DEVICE

(75) Inventor: Fukuro Koshiji, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA HOLDINGS, INC., Tokyo (JP)

(21) Appl. No.: 12/529,565

(22) PCT Filed: Jan. 21, 2008
(86) PCT No.: PCT/JP2008/050688

§ 371 Date: Sep. 2, 2009

(30) Foreign Application Priority Data
Mar. 7, 2007 (JP) 2007057287

(51) Int. Cl. H01Q 21/28; H01Q 9/16

(52) U.S. Cl. 343/893; 343/700 MS

(57) ABSTRACT

An antenna device includes a supporting board, a planar first radiating plate having a feeding point formed on a first surface of the supporting board, a transmission line electrically connected to the feeding point formed on the first surface and extending up to a side of the supporting board, and a planar second radiating plate formed on a second surface of the supporting board. The first and the second radiating plates are each formed in line symmetry with respect to the centerline of the transmission line and/or the extended line of the centerline. At least one of the first and second surfaces has a dielectric which is formed in either one of the two regions located on mutually opposite sides of the center line of the transmission line and the extended line of the center line when viewed from the thickness direction of the supporting board.

### FIELD OF THE INVENTION

The present invention relates to an antenna device, particularly relates to an antenna device having a radiating plate forming dielectric thereon.

### BACKGROUND OF THE INVENTION

with regard to the antenna device for UWB (Ultra Wideband), a Bowtie antenna which having a wide-frequency band characteristic by disposing a pair of radiating plates in a bowtie shape is known in the conventional art. The inventors of the present invention have discovered that, in the antenna device using a pair of radiating plates, a wider-band characteristic can be obtained by increasing the number of resonance points by combining plates different from each other in the plan view shape and further have discovered that, by disposing each radiating plate respectively on both sides of a supporting plate and connecting a transmission line of the one side to the radiation plate of the one side, and disposing the radiating plate on the other side face to face with the transmission line of the one side through the supporting plate, a part of the radiating plate on the other side can be used as a part of the transmission line.

On the other hand, these days, a development of miniaturizing the antenna device becomes important as the apparatuses such as information apparatuses become smaller and lighter. Responding to this requirement, an antenna device constituted to cover whole an antenna radiating element of a planer shape antenna device with dielectric is disclosed (For example, refer to Patent Document 1). Further, a three dimensional shape antenna constituted to cover the whole antenna radiating element with dielectric so as to support the antenna radiating element is disclosed (For example, refer to Patent Document 2).

Patent reference No. 1: Disclosure in Unexamined Japanese Patent Application Publication No. 2006-067251 Official Report

Patent reference No. 1: Disclosure in Unexamined Japanese Patent Application Publication No. 2005-260395 Official Report

### DISCLOSURE OF INVENTION

### Problems to be Solved by the Invention

However, in the antenna device disclosed in the Patent Document 1 and the Patent Document 2, there was a problem that it is difficult to obtain an impedance matching as it is constituted to cover the whole antenna element with dielectric and that an antenna characteristic of desired frequency frequency band is deteriorated as a loss due to the dielectric is large because it is constituted to cover the whole antenna element with the dielectric.

Further, in the antenna device disclosed in the Patent Document 2, it is difficult to obtain the impedance matching and it is difficult to obtain the desired antenna characteristic as the dielectric resides at an electric feeding point.

The present invention is made in view of such points described above, and an object of the present invention is to improve the antenna characteristic by forming dielectric at a specific position of the antenna device. That is, an object of the present invention is to provide an antenna device having antenna characteristics in accordance with an intended use.

### Means for Solving the Problems

In order to solve the above-mentioned object, the invention described in the scope of claim 1 is as following:

An antenna device comprises

a supporting board,

a planar first radiating plate having an electric feeding point formed on a first surface of the supporting board;

a transmission line electrically connected to the electric feeding point formed on the first surface and extending up to a side of the supporting board; and

a planar second radiating plate formed on a second surface of the supporting board,

wherein the first radiating plate and the second radiating plate are each formed in line symmetry with respect to a centerline of the transmission line and/or extended line of the centerline, and

on at least one of the first surface and second surface, a dielectric is formed in either one of two regions located on mutually opposite sides of the center line of the transmission line and the extended line of the center line when viewed from the thickness direction of the support board.

The invention described in the scope of claim 2 is as following:

An antenna device comprises

a supporting board,

a planar first radiating plate having an electric feeding point formed on a first surface of the supporting board;

a transmission line electrically connected to the electric feeding point formed on the first surface and extending up to one side of the supporting board; and

a planar second radiating plate formed on a second surface of the supporting board,

wherein the first radiating plate and the second radiating plate are each formed in line symmetry with respect to the centerline of the transmission line and/or extended line of the centerline, and

on at least one of the first surface and second surface, a dielectric is formed in each of two regions located on mutually opposite sides of the center line of the transmission line and the extended line of the center line when viewed from the thickness direction of the support board, wherein the dielectric formed in each of two regions has a dielectric constant different from each other.

The invention described in the scope of claim 3 is as following:

The antenna device described in either one the scopes of claim 1 or claim 2, wherein the first radiating plate is formed in a semicircular shape so that an outer border of the electric feeding point expands in an arc form toward the one side;

the second radiating plate is formed in an approximately trapezoidal shape, upper base of which locates on an opposite side to the electric feeding point, at a position where the second radiating plate does not overlap with the first radiating plate in viewing in a thickness direction of the supporting plate.

The invention described in the scope of claim 4 is as following:

The antenna device described in any one of the scopes of claims 1 through 3, wherein the antenna device is formed so that at least part of an edge of the radiating plates is covered by the dielectric.

The invention described in the scope of claim 5 is as following:

The antenna device described in any one of the scopes of claims 1 through 4, wherein the dielectric is formed at a part where the dielectric does not over laps with the electric feeding point, in viewing in a thickness direction of the supporting plate.

### EFFECTS OF THE INVENTION

According to the invention described in any one of the scopes of claims 1 through 3, since the dielectric is formed in either one of the two regions located on mutually opposite sides of the center line of the transmission line and the extended line of the center line of the support board, an antenna characteristic in a certain frequency band can be improved. Therefore the antenna device in accordance with an intended purpose can be provided.

According to the invention described in the scopes of claim 4, since the antenna device is formed so that at least part of the edge of the radiating plates is covered by the dielectric, a wave length reduction effect by the dielectric can be effectively obtained and the minimum resonance frequency can be lowered, thereby the antenna device can be miniaturized.

According to the invention described in the scopes of claim 5, since the dielectric is formed so as to avoid the electric feeding point of the radiating plate, the minimum resonance frequency can be lowered, the impedance characteristic can be improved, and thereby the antenna device can be miniaturized with improving the impedance characteristic and maintaining the wide band characteristic.

### BRIEF DESCRIPTION OF THE DRAWINGS

FIG. 1 is an outline configuration of the antenna device of the first embodiment.

FIG. 2 is a drawing to explain a function of the antenna device illustrated in FIG. 1.

FIG. 3 is a drawing to explain a function of the antenna device illustrated in FIG. 1.

FIG. 4a is a drawing illustrating the first surface of the antenna device of the first embodiment.

FIG. 4b is a drawing illustrating the second surface of the antenna device of the first embodiment.

FIG. 5 illustrates a graph showing the antenna characteristic of the antenna device of the first embodiment.

FIG. 6a is a drawing illustrating the first surface of the antenna device of the second embodiment.

FIG. 6b is a drawing illustrating the second surface of the antenna device of the second embodiment.

FIG. 7 illustrates a graph showing the antenna characteristic of the antenna device of the second embodiment.

FIG. 8a is a drawing illustrating the first surface of the antenna device of the third embodiment.

FIG. 8b is a drawing illustrating the second surface of the antenna device of the third embodiment.

FIG. 9 illustrates a graph showing the antenna characteristic of the antenna device of the third embodiment.

FIG. 10a is a drawing illustrating the first surface of the antenna device of the fourth embodiment.

FIG. 10b is a drawing illustrating the second surface of the antenna device of the fourth embodiment.

FIG. 11 illustrates a graph showing the antenna characteristic of the antenna device of the fourth embodiment.

FIG. 12a is a drawing illustrating the first surface of the antenna device of the fifth embodiment.

FIG. 12b is a drawing illustrating the second surface of the antenna device of the fifth embodiment.

FIG. 13 illustrates a graph showing the antenna characteristic of the antenna device of the fifth embodiment.

FIG. 14a is a drawing illustrating the first surface of the antenna device of the sixth embodiment.

FIG. 14b is a drawing illustrating the second surface of the antenna device of the sixth embodiment.

FIG. 15 illustrates a graph showing the antenna characteristic of the antenna device of the sixth embodiment.

FIG. 16a is a drawing illustrating the first surface of the antenna device of the seventh embodiment.

FIG. 16b is a drawing illustrating the second surface of the antenna device of the seventh embodiment.

FIG. 17 illustrates a graph showing the antenna characteristic of the antenna device of the seventh embodiment.

FIG. 18a is a drawing illustrating the first surface of the antenna device of the eighth embodiment.

FIG. 18b is a drawing illustrating the second surface of the antenna device of the eighth embodiment.

FIG. 19 illustrates a graph showing the antenna characteristic of the antenna device of the eighth embodiment.

FIG. 20a is a drawing illustrating the first surface of the antenna device of the ninth embodiment.

FIG. 20b is a drawing illustrating the second surface of the antenna device of the ninth embodiment.

FIG. 21 illustrates a graph showing the antenna characteristic of the antenna device of the ninth embodiment.

FIG. 22a is a drawing illustrating the first surface of the antenna device of the tenth embodiment.

FIG. 22b is a drawing illustrating the second surface of the antenna device of the tenth embodiment.

FIG. 23 illustrates a graph showing the antenna characteristic of the antenna device of the tenth embodiment.

FIG. 24a is a drawing illustrating the first surface of the antenna device of the eleventh embodiment.

FIG. 24b is a drawing illustrating the second surface of the antenna device of the eleventh embodiment.

FIG. 25 illustrates a graph showing the antenna characteristic of the antenna device of the eleventh embodiment.

FIG. 26a is a drawing illustrating the first surface of the antenna device of the twelfth embodiment.

FIG. 26b is a drawing illustrating the second surface of the antenna device of the twelfth embodiment.

FIG. 27 illustrates a graph showing the antenna characteristic of the antenna device of the twelfth embodiment.

FIG. 28a is a drawing illustrating the first surface of the antenna device of the thirteenth embodiment.

FIG. 28b is a drawing illustrating the second surface of the antenna device of the thirteenth embodiment.

FIG. 29 illustrates a graph showing the antenna characteristic of the antenna device of the thirteenth embodiment.

FIG. 30a is a drawing illustrating the first surface of the antenna device of the fourteenth embodiment.

FIG. 30b is a drawing illustrating the second surface of the antenna device of the fourteenth embodiment.

FIG. 31 illustrates a graph showing the antenna characteristic of the antenna device of the fourteenth embodiment.

FIG. 32a is a drawing illustrating the first surface of the antenna device of the fifteenth embodiment.

FIG. 32b is a drawing illustrating the second surface of the antenna device of the fifteenth embodiment.

FIG. 33 illustrates a graph showing the antenna characteristic of the antenna device of the fifteenth embodiment.

FIG. 34a is a drawing illustrating the first surface of the antenna device of the sixteenth embodiment.

FIG. 34b is a drawing illustrating the second surface of the antenna device of the sixteenth embodiment.

FIG. 35 illustrates a graph showing the antenna characteristic of the antenna device of the sixteenth embodiment.

FIG. 36a is a drawing illustrating the first surface of the antenna device of the seventeenth embodiment.

FIG. 36b is a drawing illustrating the second surface of the antenna device of the seventeenth embodiment.

FIG. 37 illustrates a graph showing the antenna characteristic of the antenna device of the seventeenth embodiment.

FIG. 38a is a drawing illustrating the first surface of the antenna device of the eighteenth embodiment.

FIG. 38b is a drawing illustrating the second surface of the antenna device of the eighteenth embodiment.

FIG. 39 illustrates a graph showing the antenna characteristic of the antenna device of the eighteenth embodiment.

FIG. 40a is a drawing illustrating the first surface of the antenna device of the nineteenth embodiment.

FIG. 40b is a drawing illustrating the second surface of the antenna device of the nineteenth embodiment.

FIG. 41 illustrates a graph showing the antenna characteristic of the antenna device of the nineteenth embodiment.

FIG. 42a is a drawing illustrating the first surface of the antenna device of the twentieth embodiment.

FIG. 42b is a drawing illustrating the second surface of the antenna device of the twentieth embodiment.

FIG. 43 illustrates a graph showing the antenna characteristic of the antenna device of the twentieth embodiment.

FIG. 44a is a drawing illustrating the first surface of the antenna device of the twenty-first embodiment.

FIG. 44b is a drawing illustrating the second surface of the antenna device of the twenty-first embodiment.

FIG. 45 illustrates a graph showing the antenna characteristic of the antenna device of the twenty-first embodiment.

FIG. 46a is a drawing illustrating the first surface of the antenna device of the twenty-second embodiment.

FIG. 46b is a drawing illustrating the second surface of the antenna device of the twenty-second embodiment.

FIG. 47 illustrates a graph showing the antenna characteristic of the antenna device of the twenty-second embodiment.

FIG. 48a is a drawing illustrating the first surface of the antenna device of the twenty-third embodiment.

FIG. 48b is a drawing illustrating the second surface of the antenna device of the twenty-third embodiment.

FIG. 49 illustrates a graph showing the antenna characteristic of the antenna device of the twenty-third embodiment.

FIG. 50a is a drawing illustrating the first surface of the antenna device of the twenty-fourth embodiment.

FIG. 50b is a drawing illustrating the second surface of the antenna device of the twenty-fourth embodiment.

FIG. 51 illustrates a graph showing the antenna characteristic of the antenna device of the twenty-fourth embodiment.

FIG. 52a is a drawing illustrating the first surface of the antenna device of the twenty-fifth embodiment.

FIG. 52b is a drawing illustrating the second surface of the antenna device of the twenty-fifth embodiment.

FIG. 53 illustrates a graph showing the antenna characteristic of the antenna device of the twenty-fifth embodiment.

FIG. 54a is a drawing illustrating the first surface of the antenna device of the twenty-sixth embodiment.

FIG. 54b is a drawing illustrating the second surface of the antenna device of the twenty-sixth embodiment.

FIG. 55 illustrates a graph showing the antenna characteristic of the antenna device of the twenty-sixth embodiment.

FIG. 56a is a drawing illustrating the first surface of the antenna device of the twenty-seventh embodiment.

FIG. 56b is a drawing illustrating the second surface of the antenna device of the twenty-seventh embodiment.

FIG. 57 illustrates a graph showing the antenna characteristic of the antenna device of the twenty-seventh embodiment.

FIG. 58a is a drawing illustrating the first surface of the antenna device of the twenty-eighth embodiment.

FIG. 58b is a drawing illustrating the second surface of the antenna device of the twenty-eighth embodiment.

FIG. 59 illustrates a graph showing the antenna characteristic of the antenna device of the twenty-eighth embodiment.

FIG. 60a is a drawing illustrating the first surface of the antenna device of the twenty-ninth embodiment.

FIG. 60b is a drawing illustrating the second surface of the antenna device of the twenty-ninth embodiment.

FIG. 61 illustrates a graph showing the antenna characteristic of the antenna device of the twenty-ninth embodiment.

FIG. 62a is a drawing illustrating the first surface of the antenna device of the thirtieth embodiment.

FIG. 62b is a drawing illustrating the second surface of the antenna device of the thirtieth embodiment.

FIG. 63 illustrates a graph showing the antenna characteristic of the antenna device of the thirtieth embodiment.

FIG. 64a is a drawing illustrating the first surface of the antenna device of the thirty-first embodiment.

FIG. 64b is a drawing illustrating the second surface of the antenna device of the thirty-first embodiment.

FIG. 65 illustrates a graph showing the antenna characteristic of the antenna device of the thirty-first embodiment.

FIG. 66a is a drawing illustrating the first surface of the antenna device of the thirty-second embodiment.

FIG. 66b is a drawing illustrating the second surface of the antenna device of the thirty-second embodiment.

FIG. 67 illustrates a graph showing the antenna characteristic of the antenna device of the thirty-second embodiment.

FIG. 68a is a drawing illustrating the first surface of the antenna device of the thirty-third embodiment.

FIG. 68b is a drawing illustrating the second surface of the antenna device of the thirty-third embodiment.

FIG. 69 illustrates a graph showing the antenna characteristic of the antenna device of the thirty-third embodiment.

FIG. 70a is a drawing illustrating the first surface of the antenna device of the thirty-fourth embodiment.

FIG. 70b is a drawing illustrating the second surface of the antenna device of the thirty-fourth embodiment.

FIG. 71 illustrates a graph showing the antenna characteristic of the antenna device of the thirty-fourth embodiment.

FIG. 72a is a drawing illustrating the first surface of the antenna device of the thirty-fifth embodiment.

FIG. 72b is a drawing illustrating the second surface of the antenna device of the thirty-fifth embodiment.

FIG. 73 illustrates a graph showing the antenna characteristic of the antenna device of the thirty-fifth embodiment.

FIG. 74a is a drawing illustrating the first surface of the antenna device of the thirty-sixth embodiment.

FIG. 74b is a drawing illustrating the second surface of the antenna device of the thirty-sixth embodiment.

FIG. 75 illustrates a graph showing the antenna characteristic of the antenna device of the thirty-sixth embodiment.

FIG. 76 illustrates a graph showing the radiating pattern of the antenna device of the thirty-sixth embodiment.

FIG. 77 illustrates a graph showing the radiating pattern of the antenna device of the thirty-sixth embodiment.

### DESCRIPTION OF REFERENCE NUMERALS

2: Supporting board
3: First radiating plate
4: Electric feeding point
5: Transmission line
6: Electric feeding section
7: Signal source
8: Second radiating plate
9: Impedance matching section
10: Dielectric
10a: First dielectric
10b: Second dielectric
11: Antenna device of first embodiment

### BEST MODE FOR CARRYING OUT THE INVENTION

Hereinafter, embodiments of the antenna device related to the present invention will be described by referring to drawings. However, the scope of the invention is not limited to the examples of the illustrations.

### First Embodiment

Firstly, the structure of the antenna device 11 of the first embodiment will be described.

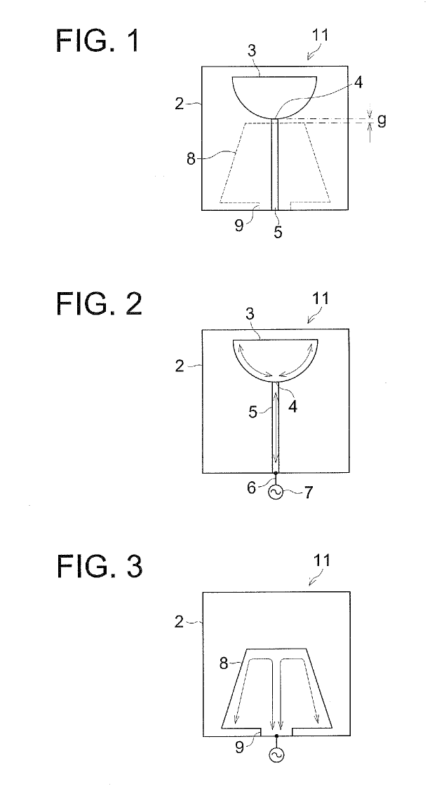

As illustrated in FIG. 1, the antenna device 11 is equipped with a planar supporting board 2. For the supporting board 2, conventional insulating material such as Teflon (registered trademark), glass epoxy, FR-4, and silicon can be appropriately employed. In the embodiment, the supporting board 2 having a thickness of 0.6 mm and formed of Teflon (registered trademark) having relative dielectric constant ∈r=2.6 is employed. Parts provided on the one surface are shown in solid lines and parts provided on the other surface are shown in broken lines.

As illustrated in FIG. 2, the first radiating plate 3 having an arc shape in planar view is provided on the one surface (after here, described as “first surface”) of the supporting board 2. The radiating plate 3 is formed in film of conductive material such as copper, aluminum, gold, silver, and platinum. The radius of the first radiating plate 3 is preferred to be from 1 mm to 15 mm and is 13.5 mm in the embodiment. The edge part of the radiating plate 3 comprises an arc section formed as an arc and a straight line section formed as a diameter of circle. The apex of the arc of the first radiating plate 3 forms the electric feeding point 4 and the transmission line 5 which extends approximately perpendicular to the straight line of the first radiating plate 3 is connected to the electric feeding point 4. The transmission line 5 is formed up to the edge part of the supporting board 2 with keeping the width of the transmission line 1.6 mm. There is no particular limitation to the width of the transmission line, however the width of the transmission line is decided in accordance with the thickness and the relative dielectric constant of the supporting plate 2. When the width of the transmission line becomes smaller, the impedance of the antenna device becomes larger. An electric feeding section 6 such as an electric feeding cable which transmits electric signals electrically is connected to the other end of the transmission line 5 and a signal source 7 such as an image processing device connects to the electric feeding section 6. The first radiating plate 3 is formed in line symmetry with respect to the center line of the transmission line 5.

As illustrated in FIG. 3, the second radiating plate 8 having an approximately trapezoidal shape in planar view is provided on the other surface (after here, described as “second surface”) of the supporting board 2. The radiating plate 3 is formed in film of conductive material such as copper, aluminum, gold, silver, and platinum. The second radiating plate 8 is formed in film of conductive material as same as the first radiating plate 3. The second radiating plate 8 is provided so that the upper base of the trapezoidal shape is opposed to the apex of the first radiating plate 3 and the upper base and the lower base of the second radiating plate 8 are approximately parallel to the straight line section of the first radiating plate 3. The radiating plate 8 is also formed in line symmetry with respect to the center line of the transmission line 5. The first radiating plate 3 and the second radiating plate 8 are arranged to have a distance of width g=0.5 mm at the supporting board 2.

Length sizes of the second radiating plate 8 are formed so that the upper base is 20 mm and the bottom base is, 38 mm, and the height is 26 mm. An impedance matching section 9 which is rectangular is provided at a center of the lower base of the second radiating plate 8. The impedance matching section 9 is formed of the material same as that of the second radiating plate 8. One example of the size of the impedance matching section 8 is that a horizontal width is 12 mm and a vertical width is 3 mm. The size of the impedance matching section can be appropriately changed according to the impedance characteristic of the antenna. In the embodiment, from a point of view of miniaturizing, a vertical width of the impedance matching section 9 is preferred to be from 1 to 10 mm and the impedance of the impedance matching section 9 is adjustable by changing the horizontal width of impedance matching section 9 and a width of transmission line 5 (strip conductor of microstrip line). Further, the impedance matching section 9 connects to the electric feeding section at the edge of the supporting board 2. That is, a part of the second radiating plate 8 which is opposed to the transmission line 5 and the impedance matching section 9 function as the transmission line (microstrip line).

Further, the first radiating plate 3 and the second radiating plate 8 are not limited to this and flat radiating plates, when they are provided on the both sides of the supporting board 2, can be arbitrarily used.

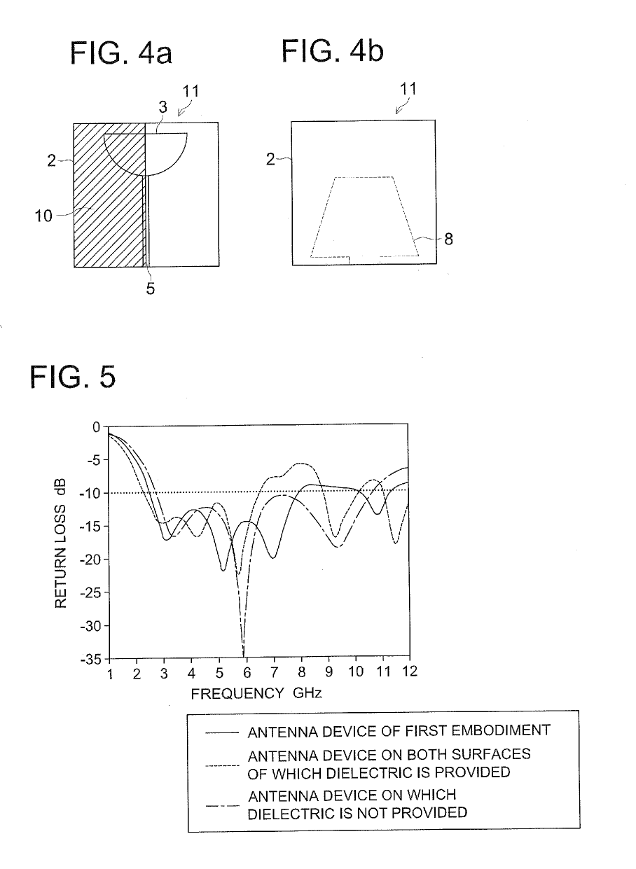

FIG. 4a illustrates the first surface viewed from the side of the first radiating plate 3. FIG. 4b illustrates the second surface viewed from the side of the first radiating plate. Further, the first surfaces and the second surfaces of the embodiments described after here also, viewed from the side of the first radiating plate, are respectively illustrated by figures having a reference “a” and by figures having reference “b” as same as the embodiment described here.

As illustrated in FIG. 4a, the dielectric 10 is formed entirely on the left half section in respect to a centerline on the first surface of the supporting board 2 so as to cover the first radiating plate 3 entirely at the left half section. The “center line” is referred to a virtual line which crosses at a center point in a width direction of the transmission line 5. Further, also in the following explanations, the left half section and the right half section are respectively referred to left and right viewed from the side of the first radiating plate 3.

For the dielectric 10, for example, ceramic, Teflon (trade mark), glass epoxy, FR-4 and so on can be used appropriately. Appropriately although it is not particularly limited, ceramic having a relative dielectric constant ∈r=10.2 with a thickness 0.6 mm is formed in the embodiment.

Next, the function of the antenna device 11 of the embodiment will be described.

In case when electric wave is transmitted by the antenna device, firstly, electric current having a predetermined amplitude and a phase flows at the electric feeding section 6 based on the signal from the signal source 7 such as signal image processor. Then, as illustrated in FIGS. 2 and 3, electric current flows, through the transmission line 5, from the electric feeding section 6 to the first radiating plate 3 and the second radiating plate 8.

Specifically, because the signal source 7 outputs alternating current signals, when positive charge flows into the side of the electric feeding section 6 to which the transmission line 5 connects and negative charge flows into the side of the electric feeding section 6 to which the second radiating plate 8 connects, at the surface of the supporting board 2 on which the first radiating plate 3 is arranged, current outputted from the signal source 7 flows on the transmission line 5 via the impedance matching section 9 through the electric feeding section 6, then from the transmission line 5 to the first radiating plate 3, and then along the arc up to the top edge of the half circle. At this time, at the surface of the supporting board 2 on which the second radiating plate 8 is arranged, current flows starting from bottom edges of sides of the trapezoid, along the sides towards top edges of the sides, then from the top edges of the side towards a center part of the upper base, then from the center part of the upper base towards a center part of the bottom base, then to the signal source 7 via the impedance matching section 9 through the electric feeding section 6.

Similarly, when negative charge flows into the side of the electric feeding section 6 to which the transmission line 5 connects and positive charge flows into the side of the electric feeding section 6 to which the second radiating plate 8 connects, at the surface of the supporting board 2 on which the second radiating plate 8 is arranged, current outputted from the signal source 7 flows from the center part of the bottom base towards the center part of the upper base via the impedance matching section 9 through the electric feeding section, then from center part of the upper base towards the top edges of the both sides, and then along the sides from top edges towards the bottom edges. At this time, at the surface of the supporting board 2 on which the first radiating plate 3 is arranged, current flows along the arc from the top edge of the half circle to the center part of arc of the first radiating plate 3, and from the center part of the arc through the transmission line 5 to the signal source 7 via the electric feeding section 6.

When the antenna device 11 receives electric wave, the first radiating plate 3 or the second radiating plate 8 receives electric wave, then standing wave current resides at the vertex of the arc for the first radiating plate 3 along the arc or the straight line part to the side of the arc, and at the center part of the upper base for the second radiating plate along both the sides, and current flows with a predetermined amplitude and phase. Then, from the first radiating plate 3, current flows from the vertex of the arc to the transmission line 5 and is transmitted to the electric feeding section 6. Further, from the second radiating plate 8, current flows from the both sides to the center of the both sides, then from the center of the upper base toward the impedance matching section 9, and then to the electric feeding section 6 via the impedance matching section. That is, because the second radiating plate 8 having the impedance matching section 9 is also equipped with a function as a transmission line, and the second radiating plate 8 is adapted to transmit current directly from the second radiating plate 8 to the electric feeding section 6.

Next, FIG. 5 illustrates the antenna characteristic of the antenna device 11. FIG. 5 also illustrates, as comparative examples, a characteristic of an antenna device which is not provided with dielectric by the dashed-dotted line and a characteristic of an antenna device of which both sides are totally covered with dielectric by the dotted line. In addition, in the embodiments described below, as comparative examples, the characteristics of the antenna devices which are not provided with dielectric are illustrated by dash-dotted line and the characteristics of the antenna devices of which both sides are totally covered with dielectric are illustrated by dotted line.

As one of indexes of the antenna characteristic, a return loss characteristic which is calculated by a ratio between an input voltage and an output voltage can be referred. The return loss characteristic is also called as a reflection coefficient, when the value is smaller, it is indicated that a matching as the antenna device is achieved better, and a range where the value is less than or equal to −10 dB is generally acknowledged to be preferred as a frequency band of use.

As illustrated in FIG. 5, in case when the electric 10 is provided on the area described above, the range where the return loss is less than or equal to −10 dB spreads from 2.4 GHz through 7.9 GHz. Further even in a range larger than 7.9 GHz, the return loss is about −8.5 dB and keeps preferable characteristic. Therefore, the frequency band of use spreads from 2.4 GHz to larger than 12 GHz.

Further, in a range from 2.7 GHz to 7.5 GHz, the return loss is less than −12.5 dB, the embodiment has a preferable characteristic compared with the case where the dielectric 10 is not provided and to the case where the dielectric is provided entirely on both sides.

On the other hand, in the case where the dielectric is provided on both sides of the antenna device 10, compared with the case where the dielectric is not provided, the characteristic of a range from middle to high frequency of 6 to 9 GHz is deteriorated and the frequency band of use becomes obviously narrower.

As described above, according to the antenna device of the embodiment, by forming the dielectric 10, compared with the case where the dielectric is not provided, it is possible to achieve to miniaturize the antenna device and widen the frequency band of use.

### Second Embodiment

Next, for the structure of the antenna device 12 of the second embodiment, different points from the first embodiment will be mainly described.

Further, the same references are assigned to the same constitutions as the first embodiment.

Further, in the embodiments described below, the different point from the first embodiment is the constitution of the dielectric 10 and this point will be described mainly.

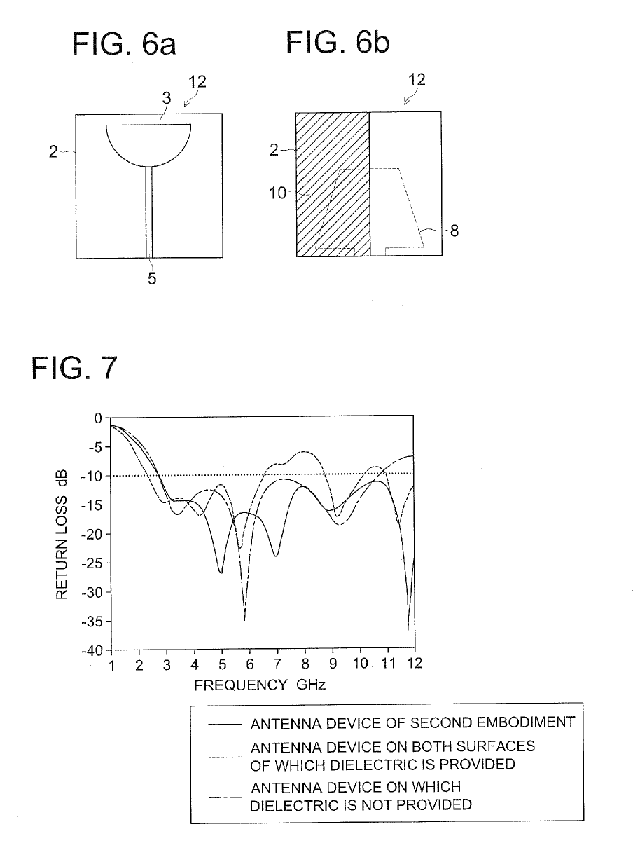

As illustrated in FIG. 6, on the second surface of the supporting board 2, 10 which covers entirely the left half part is formed.

The antenna characteristic of the antenna device 12 is shown in FIG. 7.

As shown in FIG. 7, in case where the dielectric 10 is formed as described above, the range where the return loss is less than or equal to −10 dB spreads from 2.7 GHz towards higher frequency, and the frequency band expands greatly at the higher frequency range side compared with the case where the dielectric is provided on whole the both sides.

Further, at the lower frequency side, the frequency band expands about 100 MHz towards lower frequency compared with the case where no dielectric is provided. Therefore, it can be understood that this case is effective for widening the bandwidth as well as miniaturizing.

### Third Embodiment

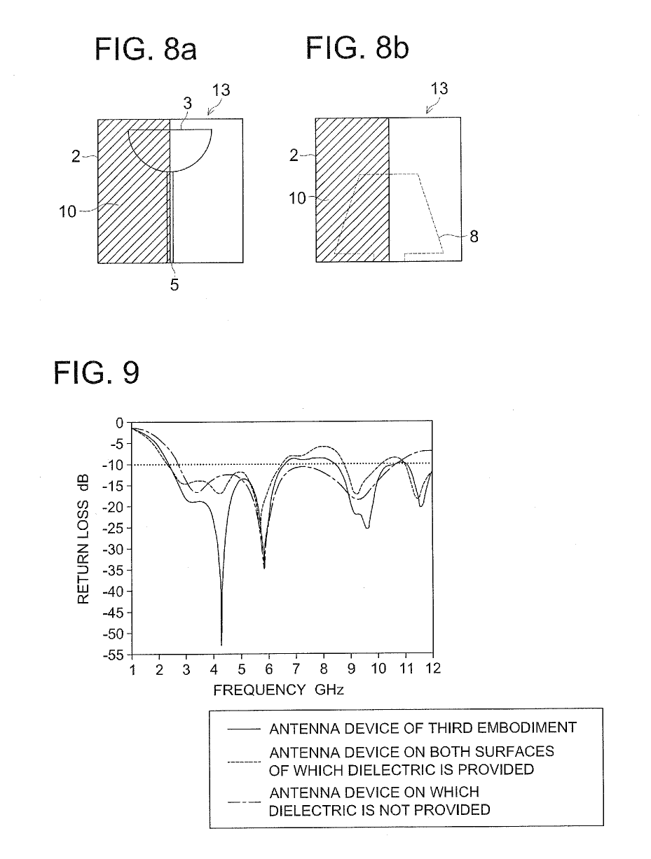

As illustrated in FIG. 8, the dielectric 10 which covers entirely the left half section in respect to the centerline on the first surface of the supporting board 2 is formed and the dielectric 10 is formed on the second surface of the supporting board 2 in a way to overlap each other with the dielectric 10 formed on the first surface.

The antenna characteristic of the antenna device 13 is shown in FIG. 9.

As shown in FIG. 9, in case where the dielectric 10 is formed as described above, the range where the return loss is less than or equal to −10 dB spreads from 2.4 GHz towards higher frequency, and the preferable antenna characteristic is shown over the wider bandwidth compared with the case where the dielectric is not provided.

Further, because the lowest frequency range where the return loss is smaller than approximately −10 dB is 2.4 GHz, and goes down almost same as the case where the dielectric 10 is provided entirely on the both surfaces, it is possible to miniaturize the antenna device 13 compared with the case where no dielectric 10 is provided.

Further, it is found that the deterioration of the characteristic is reduced at the middle wide band from 6 GHz to 9 GHz where a problem exists for the case where the dielectric is formed entirely on the both surfaces.

Further, the range from 3.1 GHz to 4.8 GHz is currently up for a frequency band used for a wireless USB as one of applications which use the UWB (Ultra Wideband) technology. In the antenna device 12 of the present embodiment, the return loss at the ranges from 3.1 GHz to 4.8 GHz is less than or equal to −15 dB and the antenna device can be used as the antenna device suitable for the wireless USB application.

### Fourth Embodiment

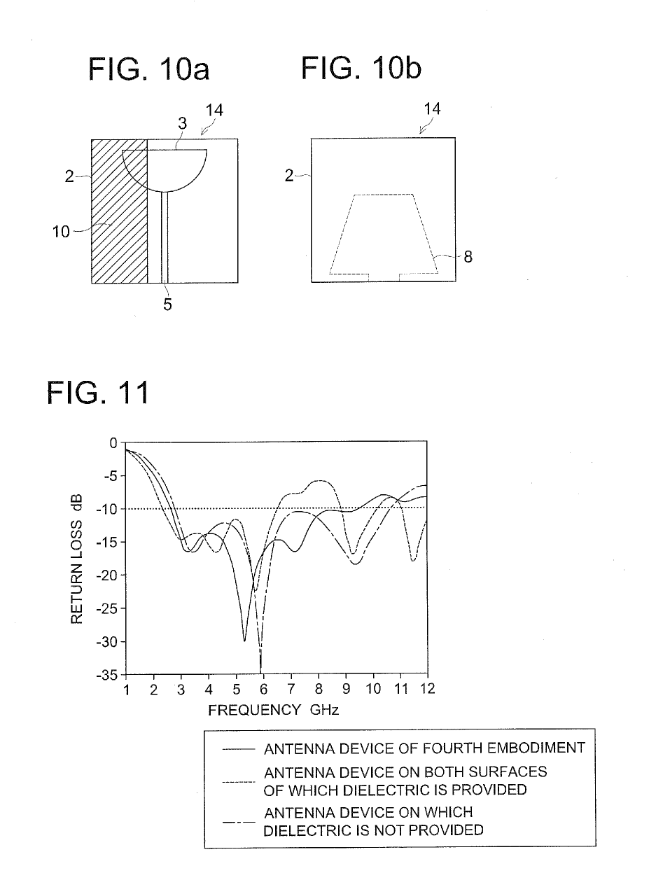

As illustrated in FIG. 10, the dielectric 10 which covers the left half section in respect to the centerline, with avoiding the transmission line 5 and the impedance matching section 9, is formed on the first surface of the supporting board 2.

The antenna characteristic of the antenna device 14 is shown in FIG. 11.

As shown in FIG. 11, in case where the dielectric 10 is formed as described above, the range where the return loss is less than or equal to −10 dB spreads from 2.5 GHz to 9.5 GHz, and further, at the ranges from 9.5 GHz towards higher frequency, the return loss is less than or equal to −8 dB, and the preferable characteristic is shown.

Further, at the range from 2.7 GHz to 7.58 GHz, the return loss is less than or equal to −12.5 dB, the antenna device is further preferable compared with the cases where the dielectric is not formed at the antenna device and the dielectric is formed entirely on the both surfaces.

### Fifth Embodiment

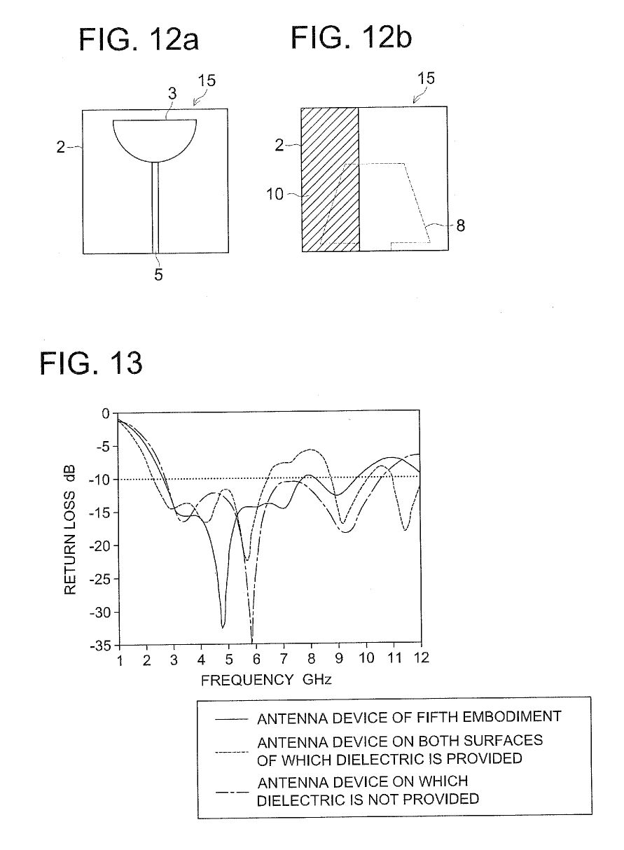

As illustrated in FIG. 12, the dielectric 10 which covers the left half section in respect to the centerline, with avoiding the transmission line 5 and the impedance matching section 9, is formed on the second surface of the supporting board 2.

The antenna characteristic of the antenna device 14 is shown in FIG. 13.

As shown in FIG. 13, in case where the dielectric 10 is formed as described above, the range where the return loss is less than or equal to −10 dB spreads from 2.6 GHz to 9.8 GHz, and the preferable characteristic is shown over the wide band.

Further, presently as described above, the range from 3.1 GHz to 4.8 GHz is up for the frequency band used for the wireless USB. In the antenna device 15 of the present embodiment, the return loss at the ranges from 3.1 GHz to 4.8 GHz is less than or equal to −15 dB and the antenna device 15 can be used as the antenna device suitable for the wireless USB application.

Further, especially in Japan, a method in which a frequency band from 4.2 GHz to 4.8 GHz is allotted as the wireless USB is employed and therefore the antenna device 15 is very much preferable as the antenna device has the return loss which is less than or equal to −17 dB at the range from 4.2 GHz to 4.8 GHz.

### Sixth Embodiment

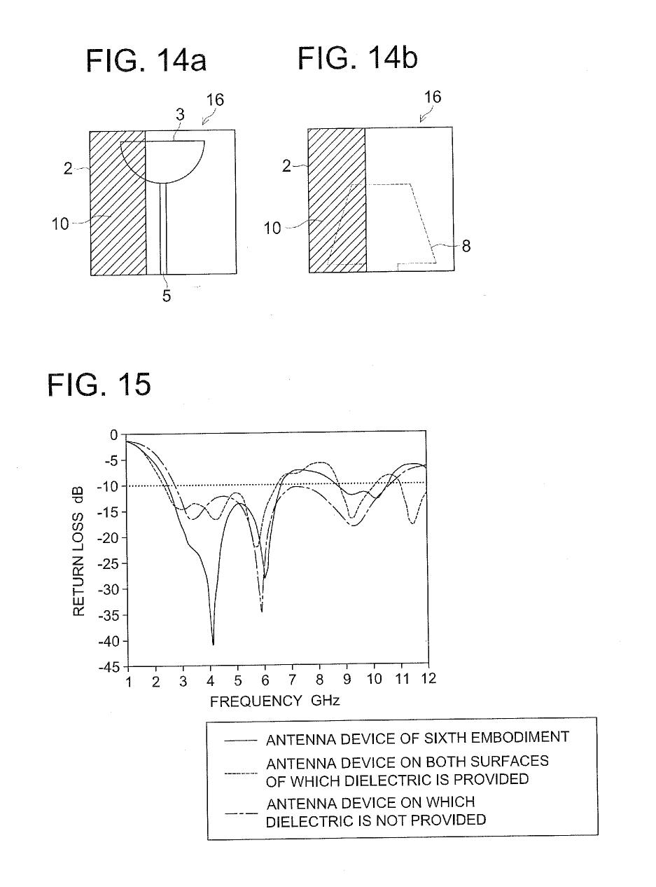

As illustrated in FIG. 14, the dielectric 10 which covers the left half section in respect to the centerline, with avoiding the transmission line 5 and the impedance matching section 9, is formed on the first surface of the supporting board 2 and the dielectric 10 is formed in such a way that the dielectric overlaps with the dielectric formed on the first surface on the second surface of the supporting board 2.

The antenna characteristic of the antenna device 16 is shown in FIG. 15.

As shown in FIG. 15, in case where the dielectric 10 is formed as described above, the range where the return loss is less than or equal to −10 dB spreads from 2.4 GHz towards higher frequency, and the preferable characteristic is shown over the wide band.

Further, because the lowest frequency where the return loss is smaller than approximately −10 dB is 2.4 GHz, and goes down almost same as the case where the dielectric 10 is provided entirely on the both surfaces, it can be understood that this case is further effective for miniaturizing the antenna device 13 compared with the case where the dielectric 10 is not provided at all.

Further, as described above, the range from 3.1 GHz to 4.8 GHz is up for the frequency band used for the wireless USB. In the antenna device 16 of the present embodiment, the return loss at the range from 3.1 GHz to 4.8 GHz is less than or equal to −15 dB and the antenna device suitable for the wireless USB application is realized.

Further, there is also a system in which a frequency band from 3.1 GHz to 4.2 GHz is employed as the wireless USB and, particularly in case when this system is employed, it can be understood that the antenna device 14 of the present embodiment is very much preferable as the return loss which is less than or equal to −20 dB at the range from 3.1 GHz to 4.2 GHz.

### Seventh Embodiment

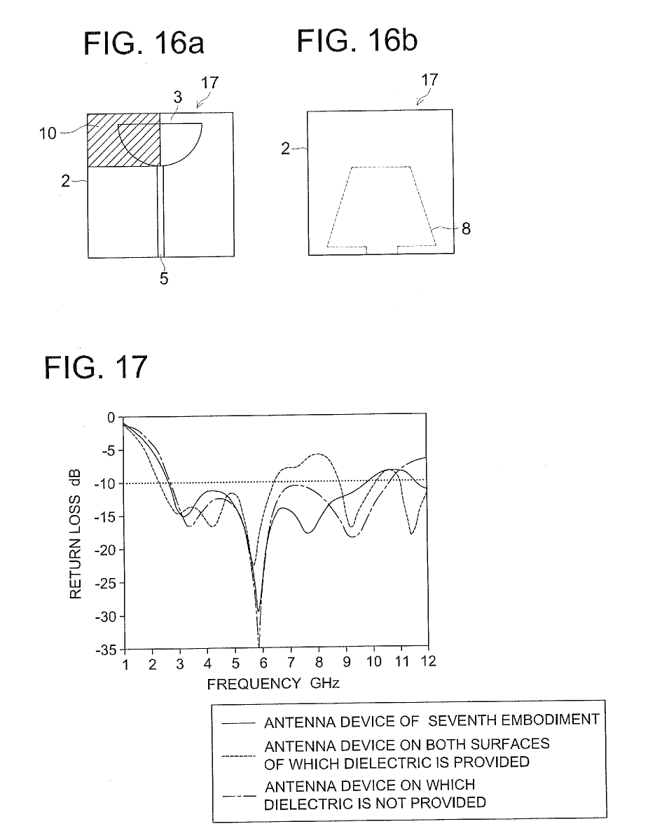

As illustrated in FIG. 16, the dielectric 10 is formed on the first surface of the supporting board 2 so as to cover the first radiating plate 3 at an upper part of the left half section in respect to the centerline.

The antenna characteristic of the antenna device 17 is shown in FIG. 17.

As shown in FIG. 17, in case where the dielectric 10 is formed as described above, the range where the return loss is less than or equal to −10 dB spreads from 2.6 GHz to 9.8 GHz, and further, also at the ranges from 9.8 GHz towards higher frequency, the return loss is less than or equal to −7 dB, and the preferable characteristic is shown.

Further, it is found that the deterioration of the characteristic is improved at the middle wide band from 6 GHz to 9 GHz where there exists a problem in case where the dielectric 10 is formed entirely on the both surfaces, by occurring of a resonance point around 7.7 GHz.

Further, because it can be assumed that an application which uses 6 GHz or more will come out in the applications of UWB from now on, the antenna device 17 of the present application can be used as the antenna device suitable for applications of UWB from now on.

### Eighth Embodiment

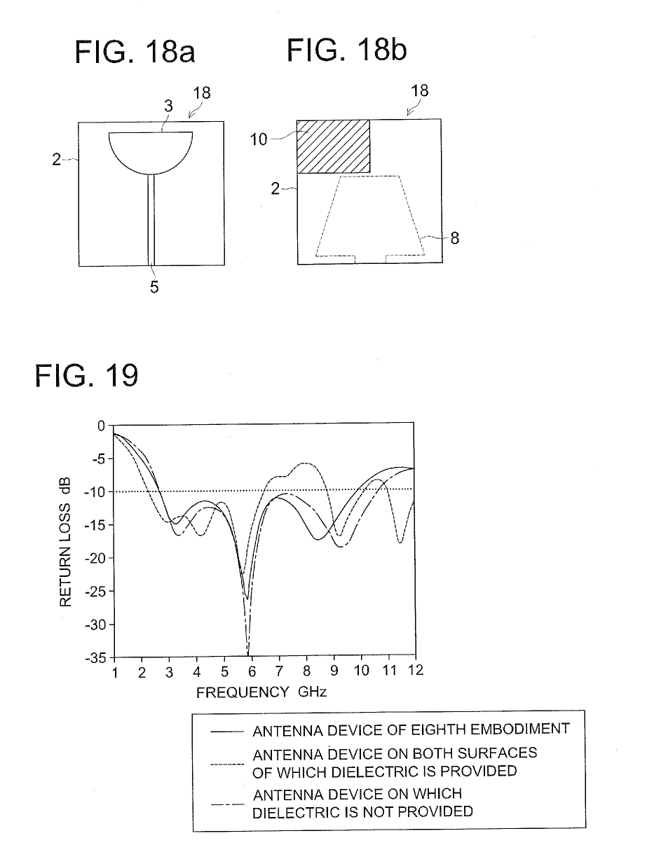

As illustrated in FIG. 18, the dielectric 10 is formed at an upper part of the left half section in respect to the centerline on the second surface of the supporting board 2 so as to avoid the second radiating plate 8.

The antenna characteristic of the antenna device 18 is shown in FIG. 19.

As shown in FIG. 19, in case where the dielectric 10 is formed as described above, the range where the return loss is less than or equal to −10 dB spreads from 2.6 GHz to 9.9 GHz, and further, also at the ranges from 9.9 GHz towards higher frequency, the return loss is less than or equal to −7 dB, and the preferable characteristic is shown.

Further, it is found that the deterioration of the characteristic is improved at the middle wide band from 6 GHz to 9 GHz where there exists a problem in case where the dielectric 10 is formed entirely on the both surfaces, by occurring of a resonance point around 7.7 GHz.

### Ninth Embodiment

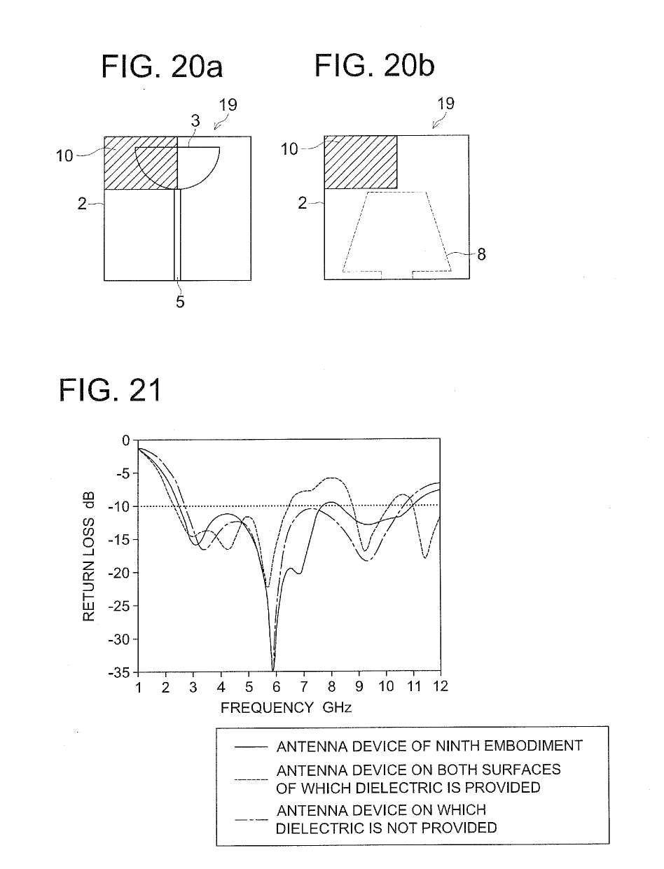

As illustrated in FIG. 20, the dielectric 10 is formed so as to cover the first radiating plate 3 at an upper part of the left half section in respect to the centerline on the first surface of the supporting board 2. Further the dielectric is formed on the second surface of the supporting board 2 so as to overlap with the dielectric formed on the first surface.

The antenna characteristic of the antenna device 19 is shown in FIG. 21.

As shown in FIG. 21, in case where the dielectric 10 is formed as described above, the range where the return loss is less than or equal to −10 dB spreads from 2.5 GHz to 11 GHz, and the embodiment has a preferable characteristic compared with the case where the dielectric 10 is not provided and to the case where the dielectric is provided entirely on both sides.

Further, because the lowest frequency where the return loss is smaller than or equal to −10 dB is 2.5 GHz, and goes down as same as the case where the dielectric 10 is provided entirely on the both surfaces, it can be understood that this case is further effective for miniaturizing the antenna device compared with the case where the dielectric 10 is not formed at all.

### Tenth Embodiment

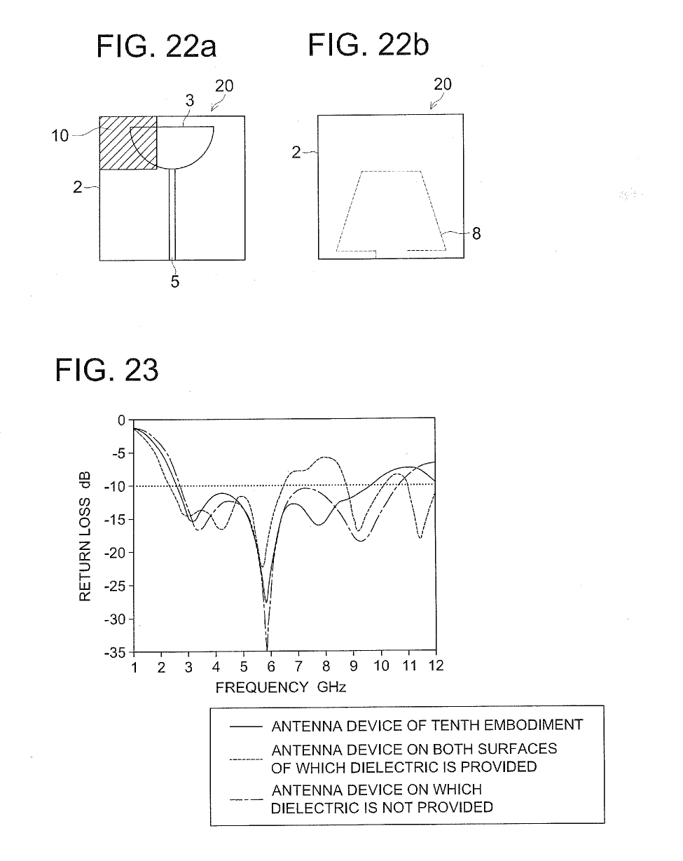

As illustrated in FIG. 22, the dielectric 10 is formed on the first surface of the supporting board 2 so as to cover the first radiating plate 3 at an upper part of the left half section in respect to the centerline and avoid the transmission line 5 and the impedance matching section 9.

The antenna characteristic of the antenna device 20 is shown in FIG. 23.

As shown in FIG. 23, in case where the dielectric 10 is formed as described above, the range where the return loss is less than or equal to −10 dB spreads from 2.6 GHz to 9.7 GHz, and further, also at the ranges from 9.7 GHz towards higher frequency, the return loss is less than or equal to −7 dB, and the preferable characteristic is shown.

Further, it is found that the deterioration of the characteristic is improved at the middle wide band from 6 GHz to 9 GHz where there exists a problem in case where the dielectric 10 is formed entirely on the both surfaces, by occurring of a resonance point around 7.7 GHz.

Further, because it can be assumed that an application which uses 6 GHz or more will come out in the applications of UWB from now on, the antenna device 20 of the present application can be used as the antenna device suitable for applications of UWB from now on.

### Eleventh Embodiment

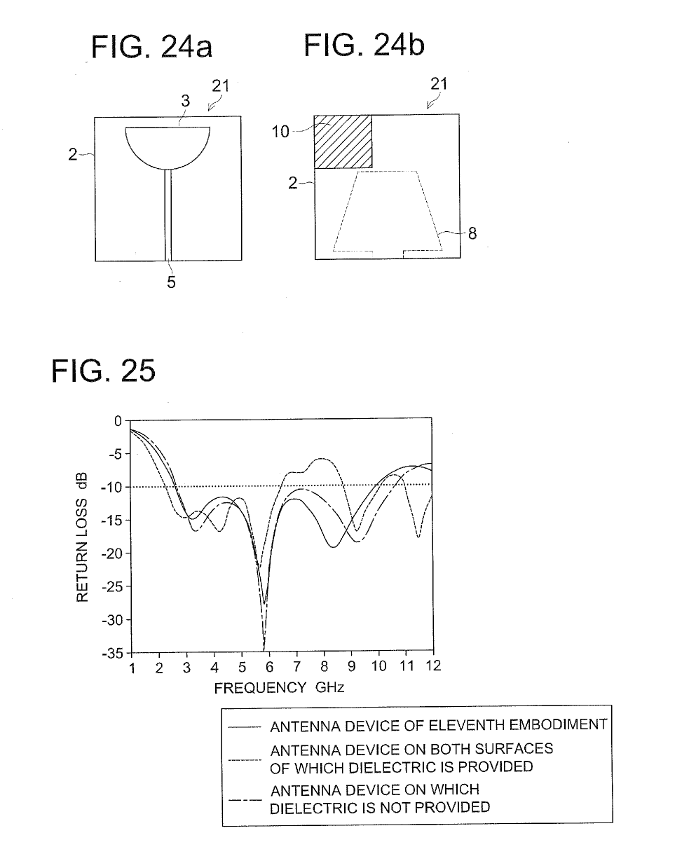

As illustrated in FIG. 24, the dielectric 10 is formed at a part of the left half section in respect to the centerline on the second surface of the supporting board 2 so as to cover the area overlapping with the first radiating plate 3 and avoid the transmission line 5 and the impedance matching section 9.

The antenna characteristic of the antenna device 21 is shown in FIG. 25.

As shown in FIG. 25, in case where the dielectric 10 is formed as described above, the range where the return loss is less than or equal to −10 dB spreads from 2.5 GHz to 10 GHz, and further, also at the ranges from 10 GHz towards higher frequency, the return loss is less than or equal to −7 dB, and the preferable characteristic is shown.

Further, it can be understood that the deterioration of the characteristic is improved at the middle wide band from 6 GHz to 9 GHz where there exists a problem in case where the dielectric 10 is formed entirely on the both surfaces, by occurring of a resonance point around 7.7 GHz.

### Twelfth Embodiment

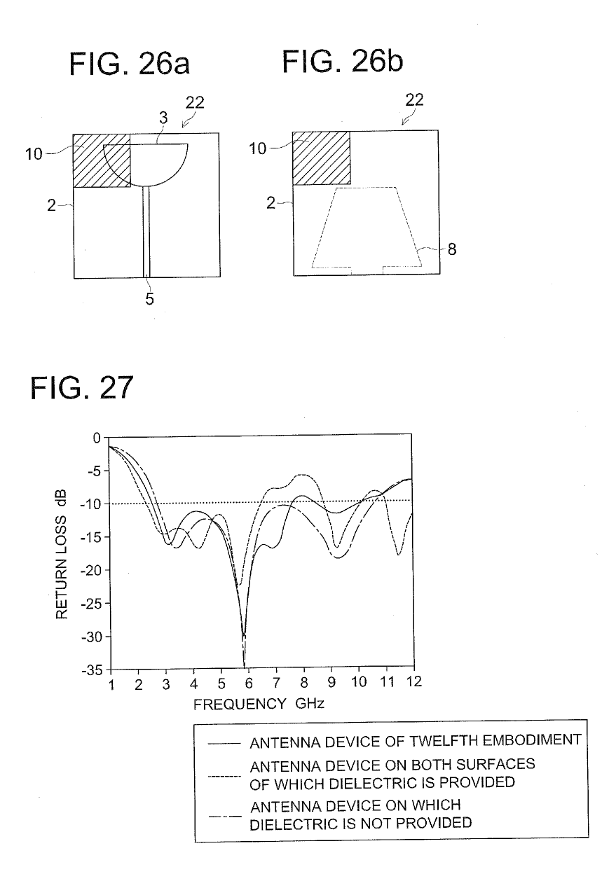

As illustrated in FIG. 26, the dielectric 10 is formed at a part of the left half section in respect to the centerline on the first surface of the supporting board 2 so as to cover the first radiating plate 3 at the part of the left half section and avoid the transmission line 5 and the impedance matching section 9. Further, the dielectric 10 is formed on the second surface of the supporting board 2 so as to overlap with the dielectric formed on the first surface.

The antenna characteristic of the antenna device 22 is shown in FIG. 27.

As shown in FIG. 27, in case where the dielectric 10 is formed as described above, the range where the return loss is less than or equal to −10 dB spreads from 2.5 GHz to 10.2 GHz, and further, also at the ranges from 10.2 GHz towards higher frequency, the return loss is less than or equal to −7 dB, and the preferable characteristic is shown.

Further, because the lowest frequency where the return loss is smaller than or equal to −10 dB is 2.5 GHz, and goes down as same as the case where the dielectric 10 is provided entirely on the both surfaces, it can be understood that this case is further effective for miniaturizing the antenna device compared with the case where the dielectric 10 is not formed.

### Thirteenth Embodiment

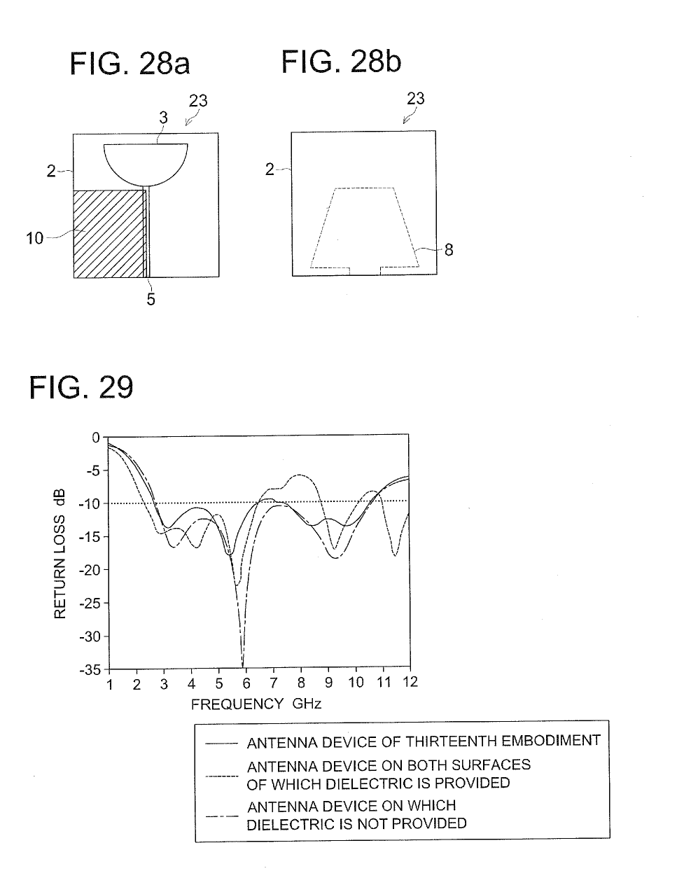

As illustrated in FIG. 28, the dielectric 10 is formed at a part of the left half section in respect to the centerline on the first surface of the supporting board 2 so as to cover the part lower than the first radiating plate 3.

The antenna characteristic of the antenna device 23 is shown in FIG. 29.

As shown in FIG. 29, in case where the dielectric 10 is formed as described above, the range where the return loss is less than or equal to −10 dB spreads from 2.6 GHz to 10.6 GHz, further, there is no deterioration of the characteristic at the middle wide band from 6 GHz to 9 GHz which is the problem in the case where the dielectric 10 is formed entirely on the both surfaces, and the preferable antenna characteristic is obtained over a wide frequency band.

Further, because the lowest frequency where the return loss is smaller than approximately −10 dB is 2.6 GHz, and goes down further compared with the case where the dielectric 10 is not formed, and it can be understood that this case is further effective for miniaturizing the antenna device compared with the case where the dielectric 10 is not formed.

### Fourteenth Embodiment

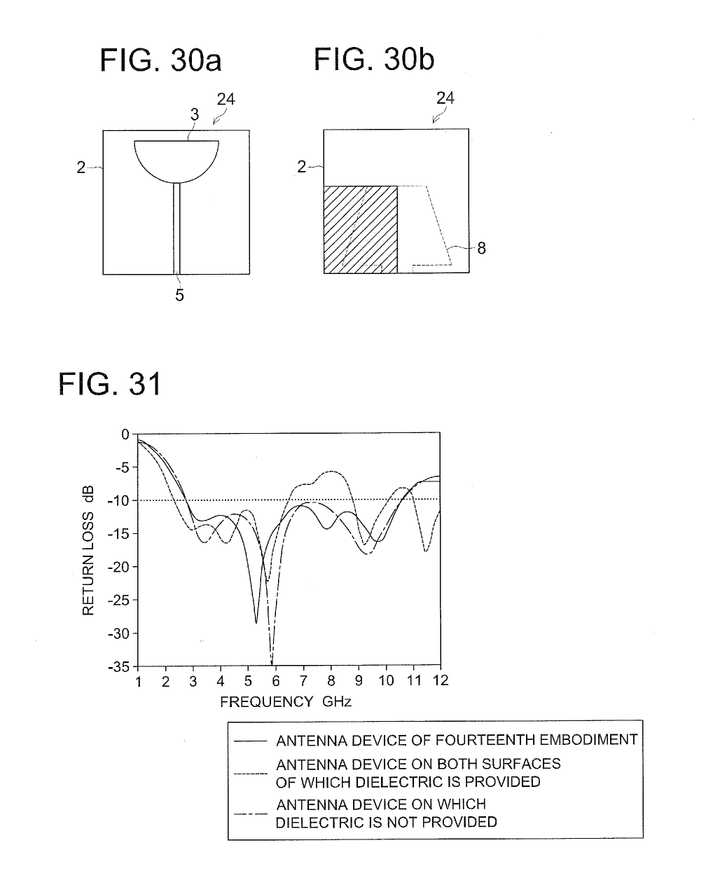

As illustrated in FIG. 30, the dielectric 10 is formed at a part of the left half section in respect to the centerline on the second surface of the supporting board 2 so as to cover the second radiating plate 8.

The antenna characteristic of the antenna device 24 is shown in FIG. 31.

As shown in FIG. 31, in case where the dielectric 10 is formed as described above, the range where the return loss is less than or equal to −10 dB spreads from 2.6 GHz to 10.6 GHz.

Further, the deterioration of the characteristic at the middle wide band from 6 GHz to 9 GHz which is the problem in the case where the dielectric 10 is formed entirely on the both surfaces is not observed, and the preferable antenna characteristic is obtained over a wide frequency band.

Further, it can be understood that the antenna characteristic around 7.7 GHz is improved compared with the case where the dielectric 10 is not provided.

### Fifteenth Embodiment

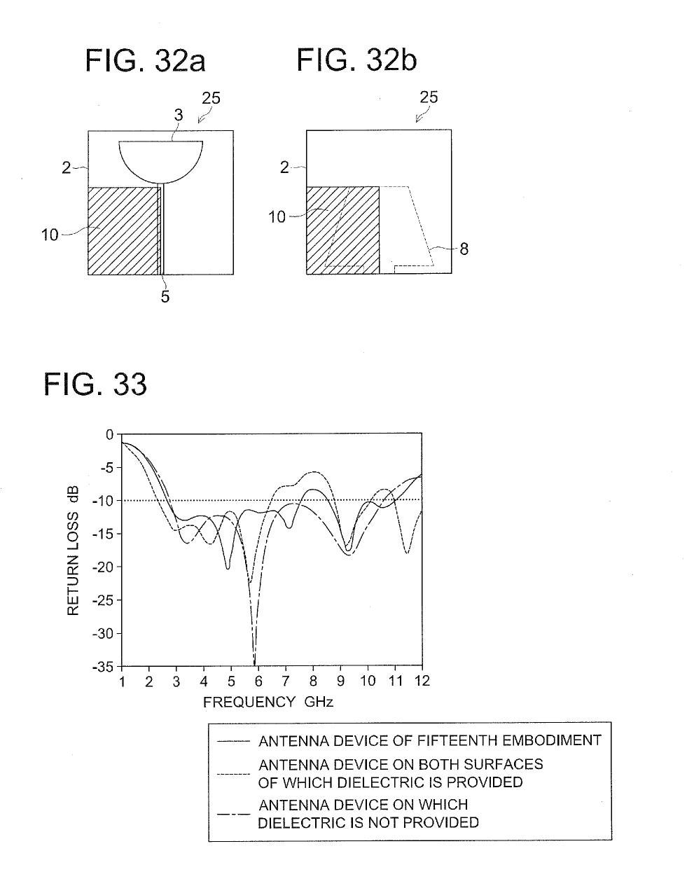

As illustrated in FIG. 32, the dielectric 10 is formed at a part of the left half section in respect to the centerline on the first surface of the supporting board 2 so as to cover the part lower than the first radiating plate 3. Further, the dielectric 10 is folued on the second surface of the supporting board 2 so as to overlap with the dielectric 10 formed on the first surface.

The antenna characteristic of the antenna device 25 is shown in FIG. 33.

As shown in FIG. 33, in case where the dielectric 10 is formed as described above, the range where the return loss is less than or equal to −10 dB spreads from 2.6 GHz to 7.5 GHz and from 8.5 GHz to 11.2 GHz. Further the return loss around 8 GHz is about −8 dB and the preferable antenna characteristic is obtained.

Therefore, the antenna operates from 2.6 GHz to 11.2 GHz and has a wider band characteristic compared with the cases where the dielectric 10 is not provided and where the dielectric 10 is provided entirely on both surfaces.

Further, the deterioration of the characteristic at the middle wide band from 6 GHz to 9 GHz which is the problem in case where the dielectric 10 is formed entirely on the both surfaces is improved.

### Sixteenth Embodiment

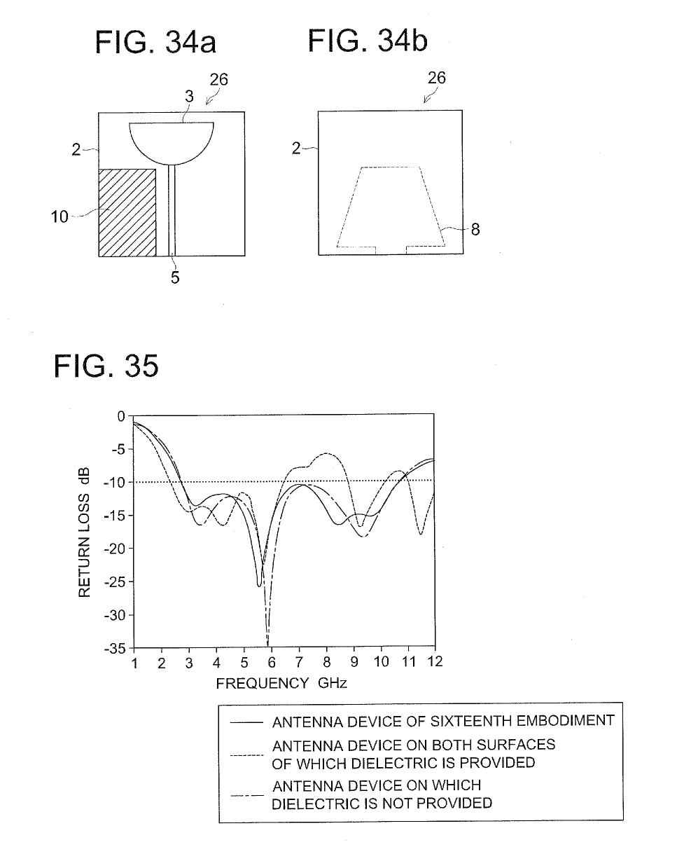

As illustrated in FIG. 34, the dielectric 10 is formed at a part of the left half section in respect to the centerline on the first surface of the supporting board 2 so as to cover the part lower than the first radiating plate 3 and avoid the transmission line 5 and the matching section 9.

The antenna characteristic of the antenna device 26 is shown in FIG. 35.

As shown in FIG. 35, in case where the dielectric 10 is formed as described above, the range where the return loss is less than or equal to −10 dB spreads from 2.6 GHz to 10.6 GHz. Further the deterioration of the characteristic at the middle wide band (from 6 GHz to 9 GHz) which is the problem in case where the dielectric 10 is pasted entirely on the bath surfaces is not observed and the preferable characteristic is obtained over the wide band.

Further, compared with the case where the dielectric 10 is not formed, the lowest frequency where the return loss is smaller than or equal to −10 dB is 2.7 GHz and is as good as the case where the dielectric 10 is not provided. Further the characteristic around 8 GHz is improved compared with the case where the dielectric 10 is formed entirely on the both surfaces.

### Seventeenth Embodiment

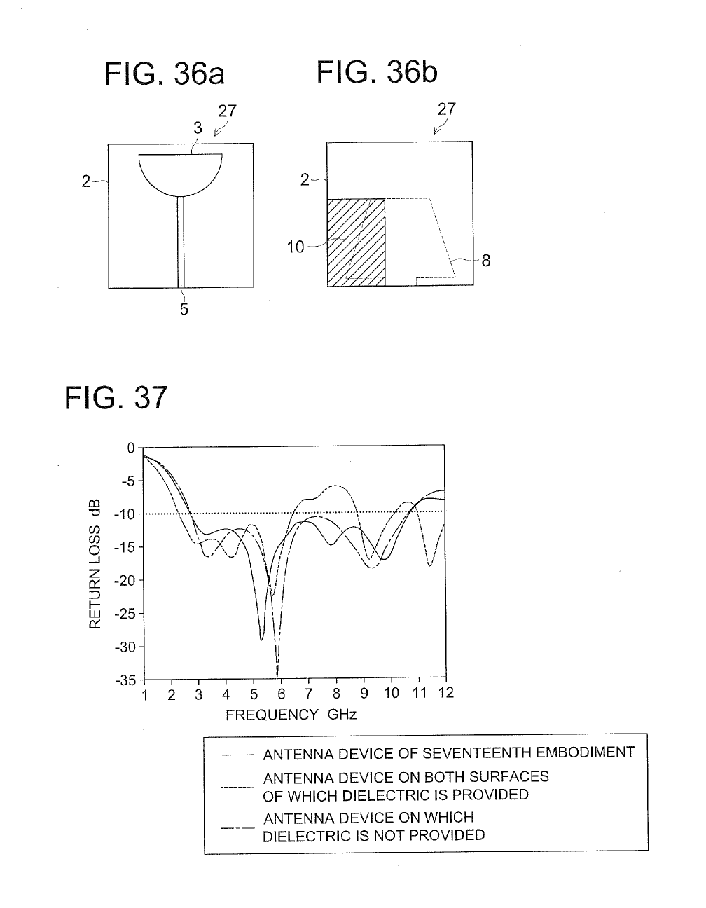

As illustrated in FIG. 36, the dielectric 10 is formed at a part of the left half section in respect to the centerline on the second surface of the supporting board 2 so as to cover the second radiating plate 8 at the part of the left half section and avoid the transmission line 5 and the matching section 9.

The antenna characteristic of the antenna device 27 is shown in FIG. 37.

As shown in FIG. 37, in case where the dielectric 10 is formed as described above, the range where the return loss is less than or equal to −10 dB spreads from 2.6 GHz to 10.6 GHz. Further the deterioration of the characteristic at the middle wide band from 6 GHz to 9 GHz which is the problem for the case where the dielectric 10 is formed entirely on both surfaces is not observed and the preferable characteristic is obtained over the wide band.

Further, the lowest frequency where the return loss is smaller than or equal to −10 dB is 2.7 GHz and is as good as the case where the dielectric 10 is not provided. Further the characteristic around 7.8 GHz is improved compared with the case where the dielectric 10 is not provided.

### Eighteenth Embodiment

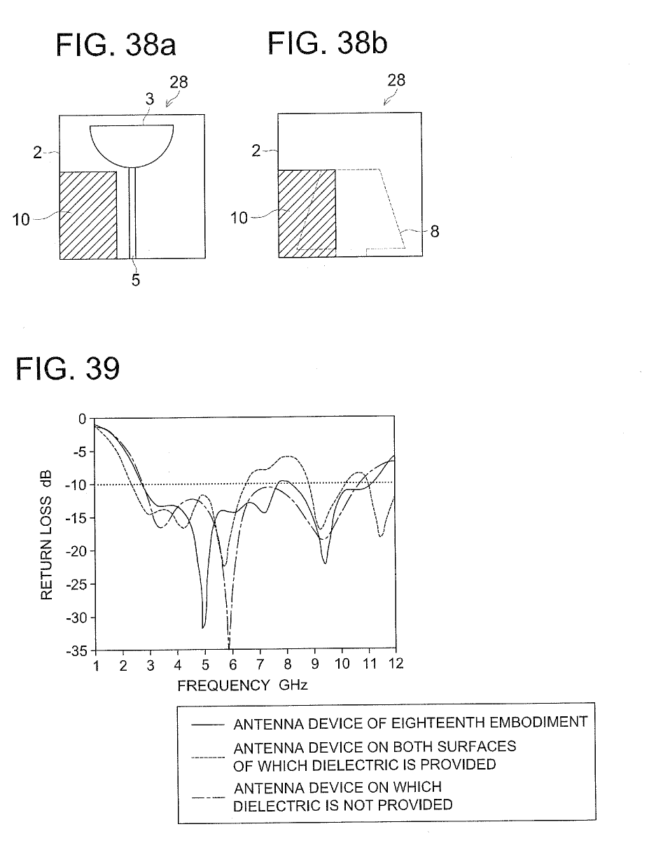

As illustrated in FIG. 38, the dielectric 10 is formed at a part of the left half section in respect to the centerline on the first surface of the supporting board 2 so as to cover the part lower than the first radiating plate 3 and avoid the transmission line 5 and the matching section 9.

Further, the dielectric 10 is formed so as to overlap with the dielectric 10 formed on the first surface, on the second surface of the supporting board 2.

The antenna characteristic of the antenna device 28 is shown in FIG. 39.

As shown in FIG. 39, in case where the dielectric 10 is formed as described above, the range where the return loss is less than or equal to −10 dB spreads from 2.7 GHz to 7.5 GHz and from 8.5 GHz to 11.2 GHz. Further the return loss around 8 GHz is about −9.5 dB and the preferable antenna characteristic is obtained.

Therefore, the operation of the antenna device 28 spreads from 2.7 GHz to 11.2 GHz and has a wider band characteristic compared with the cases where the dielectric 10 is not provided and where the dielectric 10 is provided entirely on the both surfaces.

Further, the deterioration of the characteristic at the middle wide band from 6 GHz to 9 GHz which is the problem in case where the dielectric 10 is formed entirely on the both surfaces is improved.

### Nineteenth Embodiment

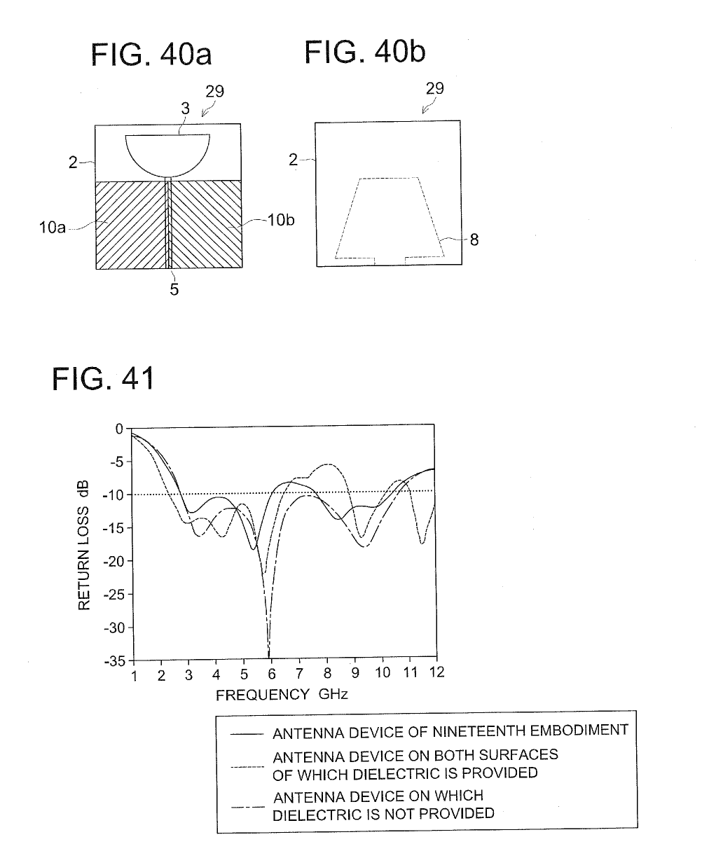

As illustrated in FIG. 40, the first dielectric 10a is formed at a part of the left half section in respect to the centerline on the first surface of the supporting board 2 and the second dielectric 10b is formed at a part of the right half section in respect to the centerline on the first surface of the supporting board 2 so that the first dielectric 10a and the second dielectric 10b avoid the first radiating plate 3.

Ceramic, Teflon (registered trademark), glass epoxy, FR-4, and so on, for example, can be appropriately employed for the first dielectric 10a and the second dielectric 10b. In the embodiment, the first dielectric 10a has a thickness of 0.6 mm formed of ceramic having relative dielectric constant ∈r=10.2 and second dielectric 10b has a thickness of 0.6 mm formed of resin having relative dielectric constant ∈r=4.5.

The combination of the material employed for the first dielectric 10a and the second dielectric 10b are not particularly limited, but can be appropriately set in accordance with the intended purposes.

The antenna characteristic of the antenna device 29 is shown in FIG. 41.

As shown in FIG. 41, in case where the first dielectric 10a and the second dielectric 10b are formed as described above, the range where the return loss is less than or equal to −10 dB spreads from 2.6 GHz to 6.1 GHz and from 7.5 GHz to 10.5 GHz. Further the return loss around 6.5 GHz is about −8 dB and the preferable antenna characteristic is obtained.

Therefore, the operation of the antenna device 29 spreads from 2.6 GHz to 10.5 GHz and has a wide band characteristic as same as the case where the dielectric 10 is not provided.

Further, the lowest frequency where the return loss is smaller than or equal to −10 dB is 2.6 GHz and goes down about 100 MHz compared with the case where the dielectric 10 is not provided and it can be realized to miniaturize the antenna device compared with the case where the dielectric 10 is not provided.

### Twentieth Embodiment

Next, the antenna device 30 relating to the twentieth embodiment will be described, mainly regarding differences from the nineteenth embodiment.

Further, in the embodiments below also, the different point from the nineteenth embodiment is a configuration of the first dielectric 10a and the second dielectric 10b and will be mainly explained. Further in the embodiments below also, similarly, to the same constitutions as those of nineteenth embodiment, same references are referred.

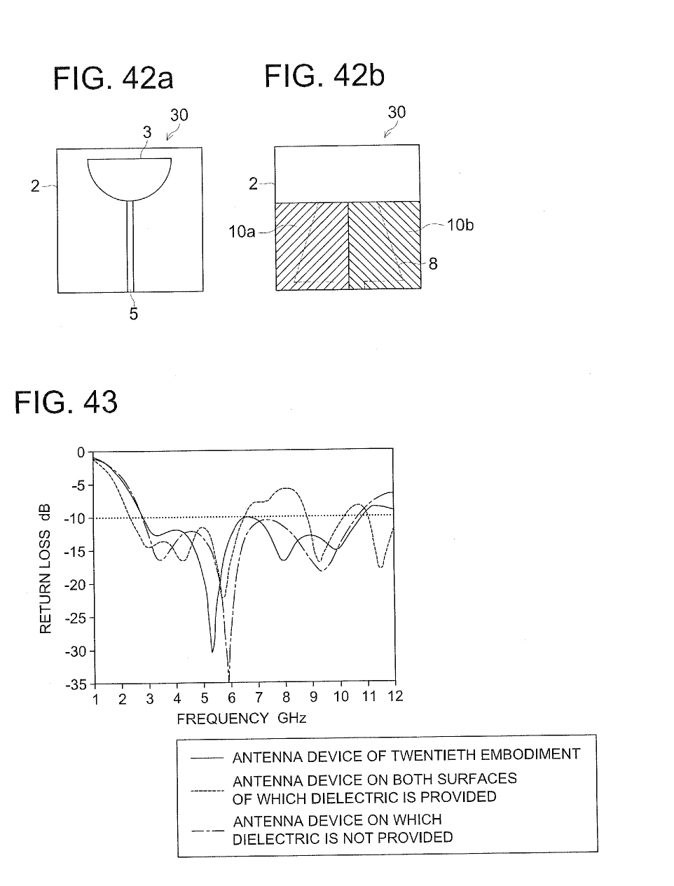

As illustrated in FIG. 42, on the second surface of the supporting board 2, the first dielectric 10a is formed at a part of the left half section in respect to the centerline and the second dielectric 10b is formed at a part of the right half section in respect to the centerline so as to cover the second radiating plate 8.

The antenna characteristic of the antenna device 30 is shown in FIG. 43.

As shown in FIG. 43, in case where the first dielectric 10a and the second dielectric 10b are formed as described above, the range where the return loss is less than or equal to −10 dB spreads from 2.7 GHz to 10.8 GHz which is the range expanded towards higher frequency side.

Further, the deterioration of the characteristic at the middle wide band from 6 GHz to 9 GHz which is the problem in case where the dielectric 10 is formed entirely on the both surfaces is improved and the preferable characteristic is obtained.

Further the characteristic around 7.8 GHz is improved compared with the case where the dielectric 10 is not provided.

### Twenty-First Embodiment

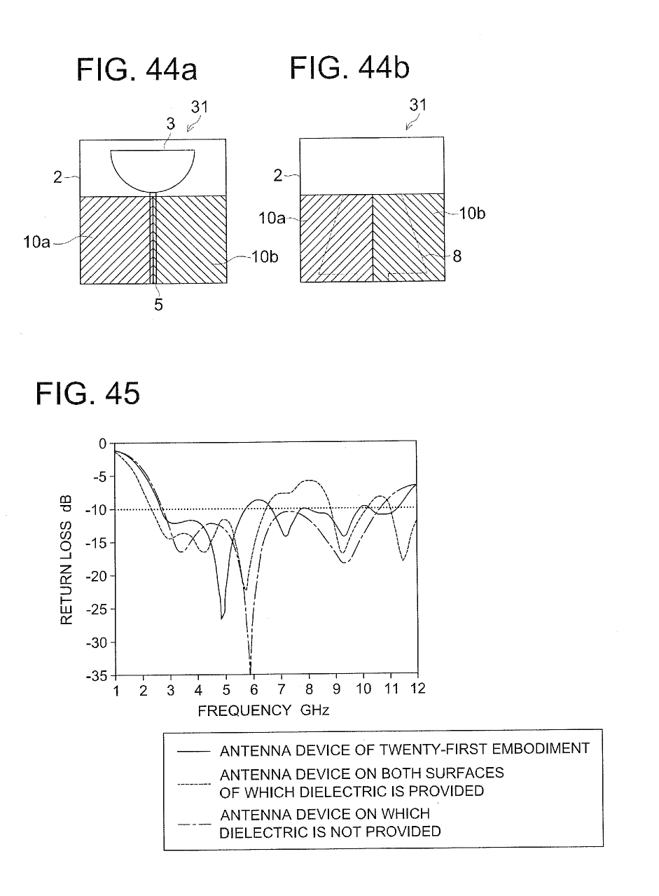

As illustrated in FIG. 44, on the first surface of the supporting board 2, the first dielectric 10a is formed at a part of the left half section in respect to the centerline and the second dielectric 10b is formed at a part of the right half section in respect to the centerline so that the first dielectric 10a and the second dielectric 10b avoid the first radiating plate 3.

Further, on the second surface of the supporting board 2, the first dielectric 10a and the second dielectric 10b are formed so as to overlap respectively the first dielectric 10a and the second dielectric 10b formed on the first surface.

The antenna characteristic of the antenna device 31 is shown in FIG. 45.

As shown in FIG. 45, in case where the first dielectric 10a and the second dielectric 10b are formed as described above, the range where the return loss is less than or equal to −10 dB spreads from 2.6 GHz to 5.7 GHz and from 6.6 GHz to 11.4 GHz. Further the return loss around 6.2 GHz is about −8 dB and the preferable characteristic is obtained.

Therefore, the antenna device 31 operates from 2.6 GHz to 11.6 GHz and has a wider band characteristic compared with the cases where the dielectric 10 is provided entirely on the both surfaces.

Further, the lowest frequency where the return loss is −10 dB is 2.6 GHz and goes down about 100 MHz compared with the case where the dielectric 10 is not provided and it can be realized to miniaturize the antenna device compared with the case where the dielectric 10 is not provided.

### Twenty-Second Embodiment

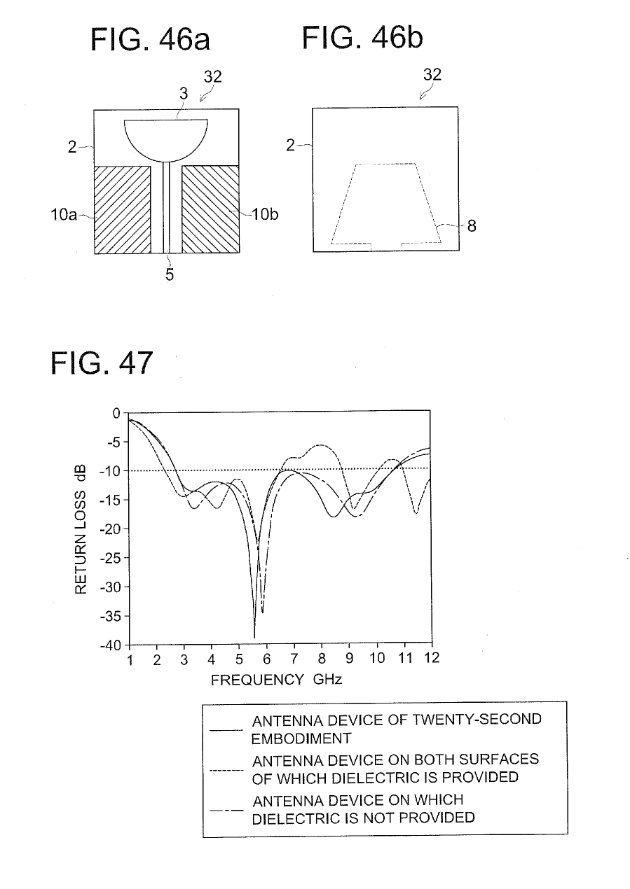

As illustrated in FIG. 46, on the first surface of the supporting board 2, the first dielectric 10a is formed at a part of the left half section in respect to the centerline and the second dielectric 10b is formed at a part of the right half section in respect to the centerline so that the first dielectric 10a and the second dielectric 10b avoid the first radiating plate 3, the transmission line 5 and the matching section 9.

The antenna characteristic of the antenna device 32 is shown in FIG. 47.

As shown in FIG. 47, in case where the first dielectric 10a and the second dielectric 10b are formed as described above, the range where the return loss is less than or equal to −10 dB spreads from 2.7 GHz to 10.7 GHz.

Further, the deterioration of the characteristic at the middle wide band from 6 GHz to 9 GHz which is the problem in case where the dielectric 10 is formed entirely on the both surfaces disappears and the preferable characteristic is obtained.

Further the characteristic around 8.4 GHz is improved compared with the case where the dielectric 10 is not provided.

### Twenty-Third Embodiment

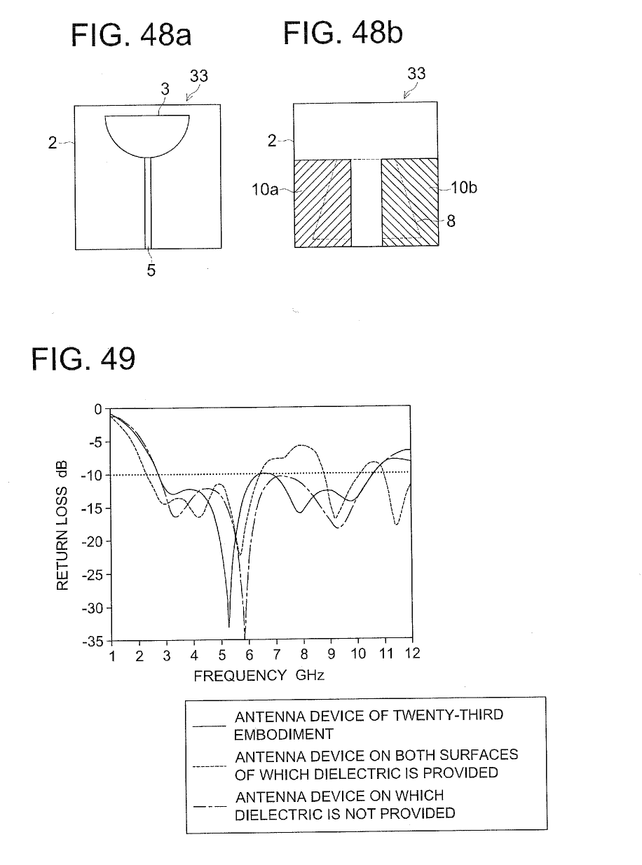

As illustrated in FIG. 48, on the second surface of the supporting board 2, the first dielectric 10a is formed at a part of the left half section in respect to the centerline and the second dielectric 10b is formed at a part of the right half section in respect to the centerline so that the first dielectric 10a and the second dielectric 10b avoid the first radiating plate 3, the transmission line 5 and the matching section 9.

The antenna characteristic of the antenna device 33 is shown in FIG. 49.

As shown in FIG. 49, in case where the first dielectric 10a and the second dielectric 10b are formed as described above, the range where the return loss is less than or equal to −10 dB spreads from 2.7 GHz to 10.8 GHz, that is the range expanded towards higher frequency side.

The deterioration of the characteristic at the middle wide band from 6 GHz to 9 GHz which is the problem in case where the dielectric 10 is formed entirely on the both surfaces disappears and the preferable characteristic is obtained. Further, around 7.9 GHz, better characteristic than the case where the dielectric 10 is not provided is obtained.

### Twenty-Fourth Embodiment

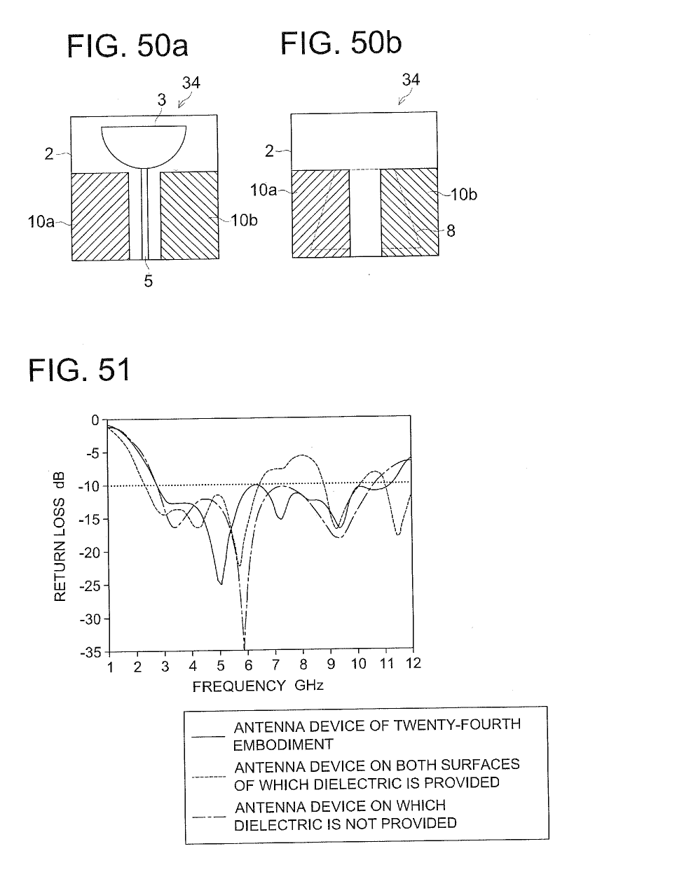

As illustrated in FIG. 50, on the first surface of the supporting board 2, the first dielectric 10a is formed at a part of the left half section in respect to the centerline and the second dielectric 10b is formed at a part of the right half section in respect to the centerline so that the first dielectric 10a and the second dielectric 10b avoid the first radiating plate 3, the transmission line 5 and the matching section 9. Further on the second surface of the supporting board 2, the first dielectric 10a and the second dielectric 10b are formed so as to overlap respectively the first dielectric 10a and the second dielectric 10b formed on the first surface.

The antenna characteristic of the antenna device 34 is shown in FIG. 51.

As shown in FIG. 51, in case where the first dielectric 10a and the second dielectric 10b are formed as described above, the range where the return loss is less than or equal to −10 dB spreads from 2.6 GHz to 11.3 GHz and it can be understood that wider band characteristic is obtained compared with the case where the dielectric 10 is not provided.

### Twenty-Fifth Embodiment)

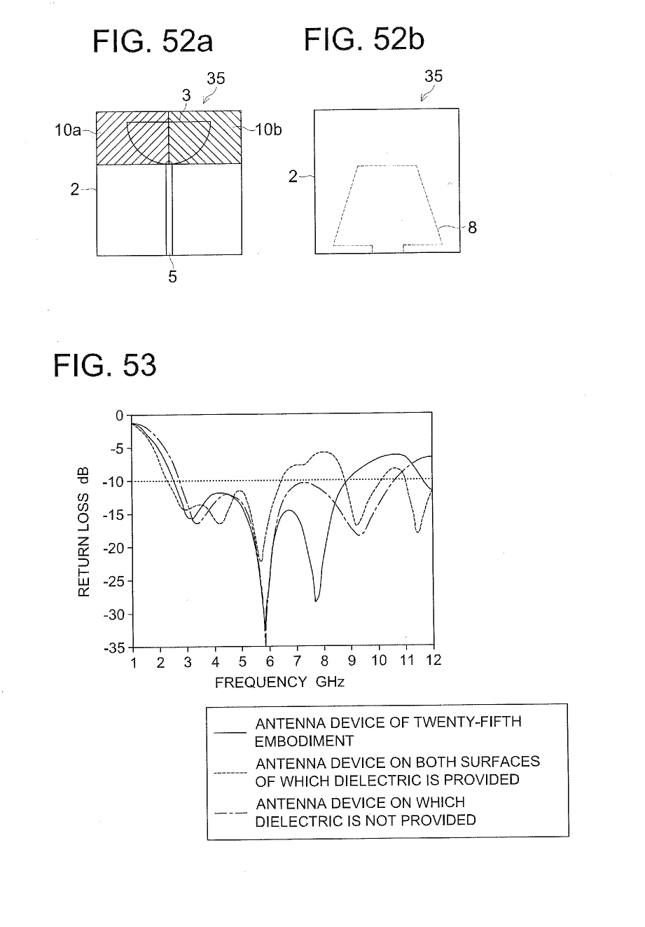

As illustrated in FIG. 52, on the first surface of the supporting board 2, the first dielectric 10a is formed at an upper part of the left half section in respect to the centerline and the second dielectric 10b is formed at an upper part of the right half section in respect to the centerline.

The antenna characteristic of the antenna device 35 is shown in FIG. 53.

As shown in FIG. 53, in case where the first dielectric 10a and the second dielectric 10b are formed as described above, the range where the return loss is less than or equal to −10 dB spreads from 2.5 GHz to 8.9 GHz and although the frequency band itself is narrower than the case where the dielectric 10 is not provided, the frequency band is wider than the frequency band of the case where the same kind of the dielectric 10 is provided entirely on both surfaces.

Further, the deterioration of the characteristic at the middle wide band from 6 GHz to 9 GHz which is the problem in case where the dielectric 10 of the same kind is formed entirely on the both surfaces is improved by the resonance around 7.7 GHz.

Further, the lowest frequency where the return loss is smaller than and equal to −10 dB is 2.5 GHz and goes down as same as the case where the dielectric 10 is adhered to the both surfaces of the antenna device, it can be understood that this case is effective also for miniaturizing the antenna device compared with the case where the dielectric 10 is not provided.

### Twenty-Sixth Embodiment)

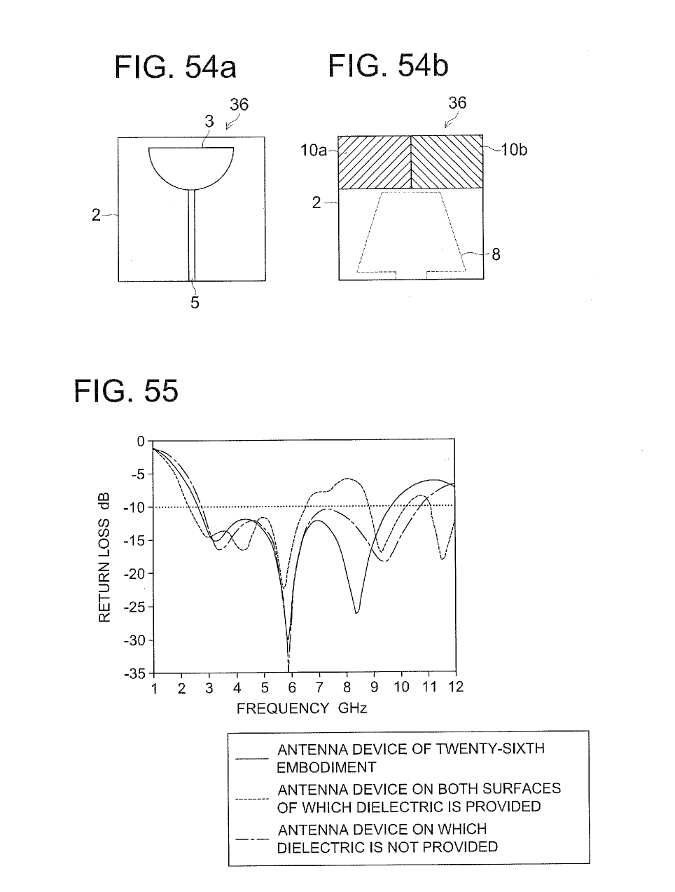

As illustrated in FIG. 54, on the second surface of the supporting board 2, the first dielectric 10a is formed at an upper part of the left half section in respect to the centerline and the second dielectric 10b is formed at an upper part of the right half section in respect to the centerline.

The antenna characteristic of the antenna device 36 is shown in FIG. 55.

As shown in FIG. 55, in case where the first dielectric 10a and the second dielectric 10b are formed as described above, the range where the return loss is less than or equal to −10 dB spreads from 2.6 GHz to 9.6 GHz and although the frequency band itself is narrower than the case where the dielectric 10 is not provided, the frequency band is wider than the case where the same kind of the dielectric 10 is provided entirely on the both surfaces.

Further, the deterioration of the characteristic at the middle wide band from 6 GHz to 9 GHz which is the problem in case where the dielectric 10 of the same kind is formed entirely on the both surfaces is improved by the resonance around 8.3 GHz.

Further, the lowest frequency where the return loss is smaller than or equal to −10 dB is 2,6 GHz and goes down as same as the case where the dielectric 10 is adhered entirely to the both surfaces of the antenna device, it can be understood that this case is effective also for miniaturizing the antenna device compared with the case where the dielectric 10 is not provided.

### Twenty-Seventh Embodiment

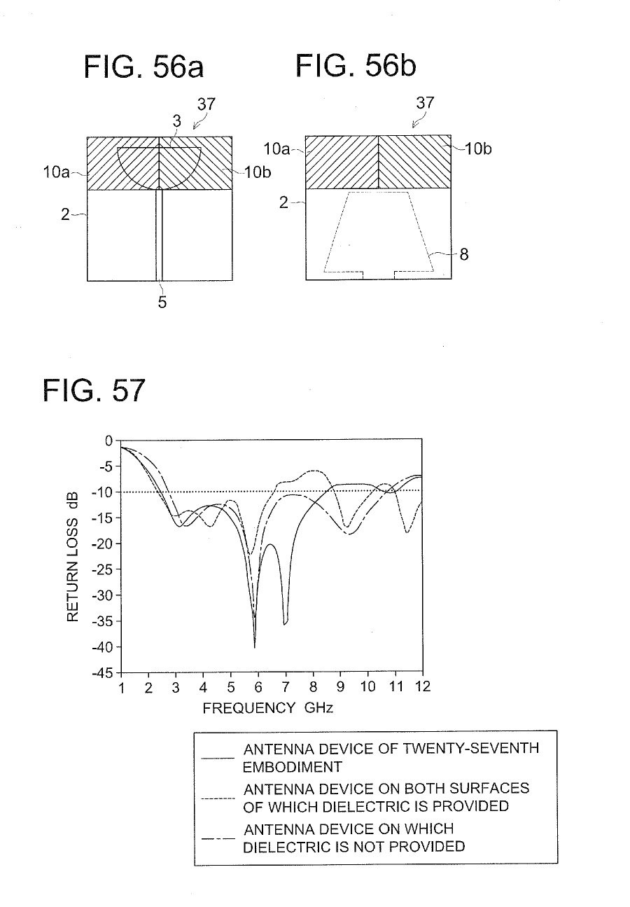

As illustrated in FIG. 56, on the first surface of the supporting board 2, the first dielectric 10a is formed at an upper part of the left half section in respect to the centerline and the second dielectric 10b is formed at an upper part of the right half section in respect to the centerline. Further on the second surface of the supporting board 2, the first dielectric 10a and the second dielectric 10b are formed so as to overlap respectively the first dielectric 10a and the second dielectric 10b formed on the first surface.

The antenna characteristic of the antenna device 37 is shown in FIG. 57.

As shown in FIG. 57, in case where the first dielectric 10a and the second dielectric 10b are formed as described above, the range where the return loss is less than or equal to −10 dB spreads from 2.4 GHz to 8.4 GHz. Further, also at the ranges from 8.4 GHz towards higher frequency, the return loss is about −8 dB, and the preferable characteristic is obtained.

Further, the frequency band characteristic is wider compared with the cases where the dielectric 10 is not provided and where the dielectric 10 of the same kind is provided entirely on the both surfaces.

Further, the deterioration of the characteristic at the middle wide band from 6 GHz to 9 GHz which is the problem in case where the dielectric 10 of the same kind is formed entirely on the both surfaces is improved by the resonance around 7 GHz.

Further, the lowest frequency where the return loss is smaller than or equal to −10 dB is 2.4 GHz and goes down as same as the case where the dielectric 10 is pasted entirely on the both surfaces of the antenna device, it can be understood that this case is effective also for miniaturizing the antenna device compared with the case where the dielectric 10 is not provided.

### Twenty-Eighth Embodiment

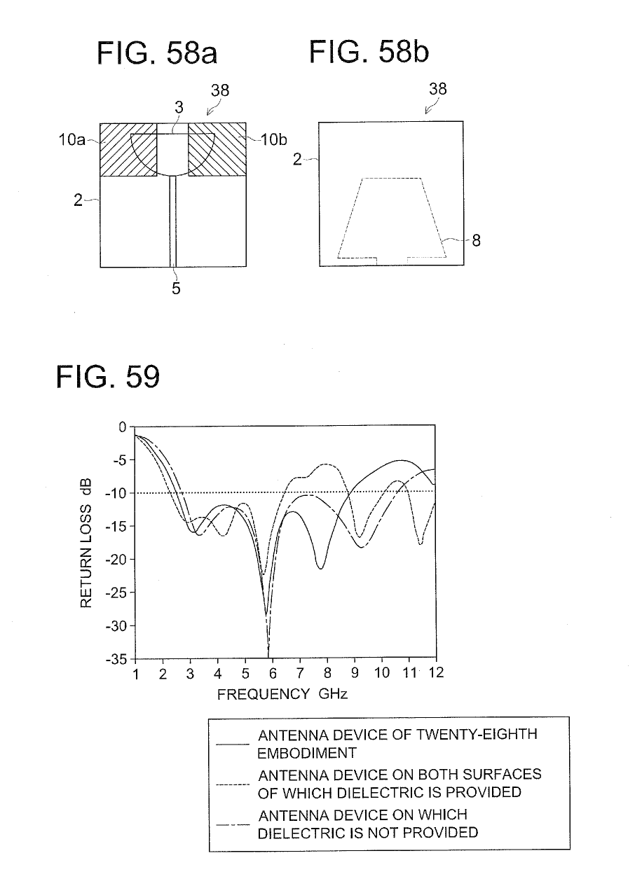

As illustrated in FIG. 58, on the first surface of the supporting board 2, the first dielectric 10a is formed at an upper part of the left half section in respect to the centerline and the second dielectric 10b is formed at an upper part of the right half section in respect to the centerline, so that first dielectric 10a and the second dielectric 10b avoid the first radiating plate 3, the transmission line 5 and the matching section 9.

The antenna characteristic of the antenna device 38 is shown in FIG. 59.

As shown in FIG. 59, in case where the first dielectric 10a and the second dielectric 10b are formed as described above, the range where the return loss is less than or equal to −10 dB spreads from 2.5 GHz to 8.9 GHz. Although the frequency band itself is narrower than the case where the dielectric 10 is not provided, the frequency band is wider than the frequency band of the case where the same kind of the dielectric 10 is provided entirely on the both surfaces.

Further, the deterioration of the characteristic at the middle wide band from 6 GHz to 9 GHz which is the problem in case where the dielectric 10 of the same kind is formed entirely on the both surfaces is improved by the resonance around 7.7 GHz.

Further, the lowest frequency where the return loss is smaller than or equal to −10 dB is 2.5 GHz and goes down as same as the case where the dielectric 10 is adhered entirely to the both surfaces of the antenna device, it can be understood that this case is effective also for miniaturizing the antenna device compared with the case where the dielectric 10 is not provided.

### Twenty-Ninth Embodiment

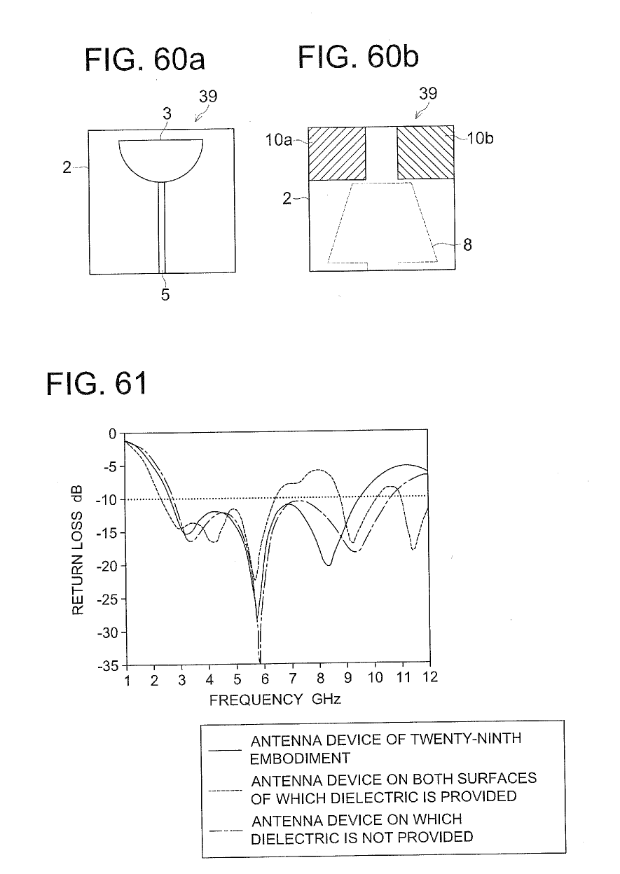

As illustrated in FIG. 60, on the second surface of the supporting board 2, the first dielectric 10a is formed at an upper part of the left half section in respect to the centerline and the second dielectric 10b is formed at an upper part of the right half section in respect to the centerline, so as to avoid the first radiating plate 3, the transmission line 5 and the matching section 9.

The antenna characteristic of the antenna device 39 is shown in FIG. 61.

As shown in FIG. 61, in case where the first dielectric 10a and the second dielectric 10b are formed as described above, the range where the return loss is less than or equal to −10 dB spreads from 2.6 GHz to 9.5 GHz and although the frequency band itself is narrower than the case where the dielectric 10 is not provided, the frequency band is wider than the frequency band of the case where the same kind of the dielectric 10 is provided entirely on the both surfaces.

Further, the deterioration of the characteristic at the middle wide band from 6 GHz to 9 GHz which is the problem in case where the dielectric 10 of the same kind is formed entirely on the both surfaces is improved by the resonance around 8.3 GHz.

Further, the lowest frequency where the return loss is smaller than or equal to −10 dB is 2.6 GHz and goes down as same as the case where the dielectric 10 is adhered entirely to the both surfaces of the antenna device, it can be understood that this case is effective also for miniaturizing the antenna device compared with the case where the dielectric 10 is not provided.

### Thirtieth Embodiment

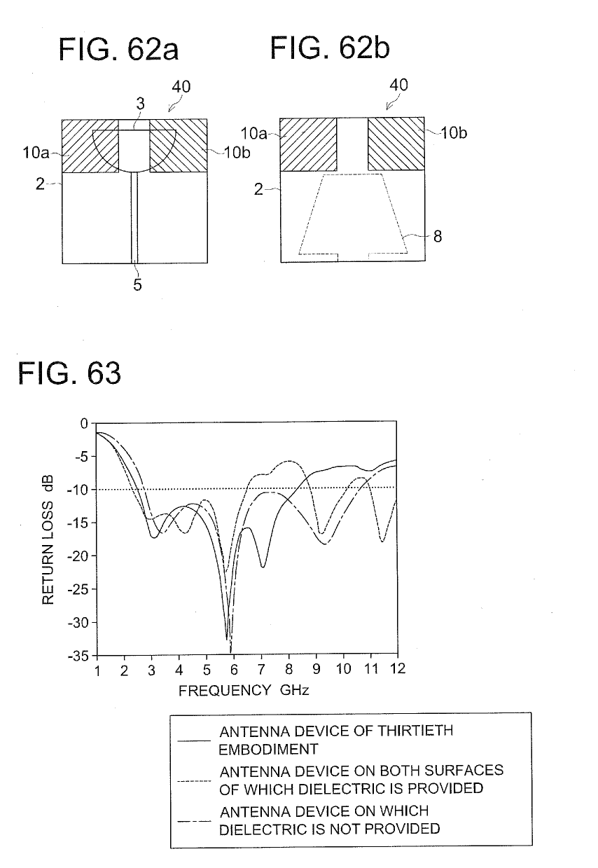

As illustrated in FIG. 62, on the first surface of the supporting board 2, the first dielectric 10a is formed at an upper part of the left half section in respect to the centerline and the second dielectric 10b is formed at an upper part of the right half section in respect to the centerline so that the first dielectric 10a and the second dielectric 10b avoid the first radiating plate 3, the transmission line 5 and the matching section 9. Further on the second surface of the supporting board 2, the first dielectric 10a and the second dielectric 10b are formed so as to overlap respectively the first dielectric 10a and the second dielectric 10b formed on the first surface.

The antenna characteristic of the antenna device 40 is shown in FIG. 63.

As shown in FIG. 63, in case where the first dielectric 10a and the second dielectric 10b are formed as described above, the range where the return loss is less than or equal to −10 dB spreads from 2.4 GHz to 8.3 GHz and the characteristic of wider frequency band is obtained compared with the case where the dielectric 10 of the same kind are provided entirely on the both surfaces.

Further, the deterioration of the characteristic at the middle wide band from 6 GHz to 9 GHz which is the problem in case where the dielectric 10 of the same kind is formed entirely on the both surfaces is improved by the resonance around 7 GHz.

Further, the lowest frequency where the return loss is smaller than −10 dB is 2.4 GHz and goes down as same as the case where the dielectric 10 is adhered entirely to the both surfaces of the antenna device, it can be understood that this case is effective also for miniaturizing the antenna device compared with the case where the dielectric 10 is not provided.

### Thirty-First Embodiment

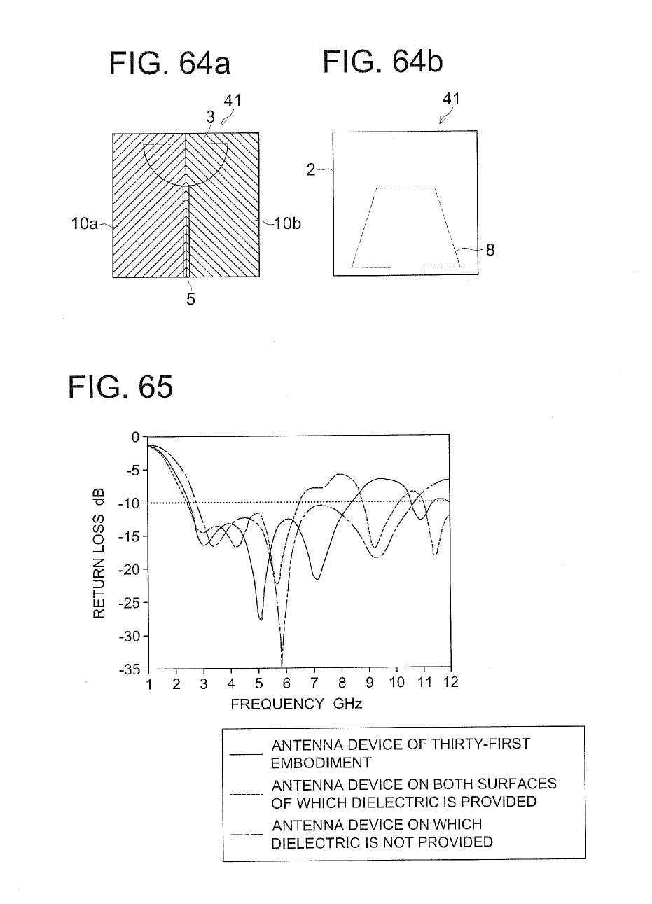

As illustrated in FIG. 64, the first dielectric 10a is formed entirely at of the left half section in respect to the centerline on the first surface of the supporting board 2 and the second dielectric 10b is formed entirely at the right half section in respect to the centerline on the first surface of the supporting board 2.

The antenna characteristic of the antenna device 41 is shown in FIG. 65.

As shown in FIG. 65, in case where the first dielectric 10a and the second dielectric 10b are formed as described above, the range where the return loss is less than or equal to −10 dB spreads from 2.4 GHz to 8.3 GHz and the characteristic of wider frequency band is obtained compared with the case where the dielectric 10 of the same kind are provided entirely on the both surfaces. Further, it can be understood that the deterioration of the characteristic at the middle wide band from 6 GHz to 9 GHz which is the problem in case where the dielectric 10 of the same kind is formed entirely on the both surfaces is improved by the resonance around 7 GHz.

Further, the lowest frequency where the return loss is smaller than or equal to −10 dB is 2.4 GHz and goes down as same as the case where the dielectric 10 is adhered entirely to the both surfaces of the antenna device, this case is effective also for miniaturizing the antenna device compared with the case where the dielectric 10 is not provided.

### Thirty-Second Embodiment

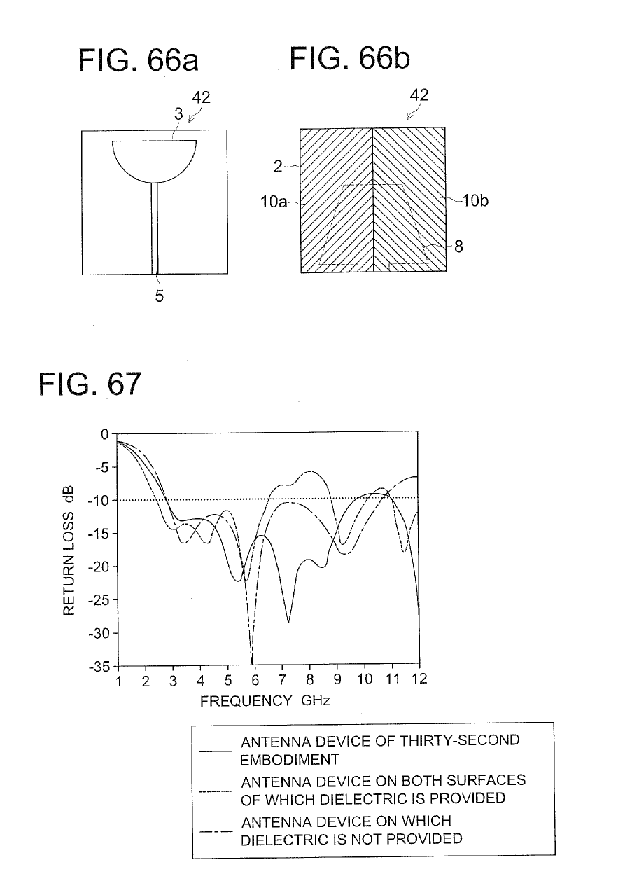

As illustrated in FIG. 66, the first dielectric 10a is formed entirely at the left half section in respect to the centerline on the second surface of the supporting board 2 and the second dielectric 10b is formed entirely at the right half section in respect to the centerline on the second surface of the supporting board 2.

The antenna characteristic of the antenna device 42 is shown in FIG. 67.

As shown in FIG. 67, in case where the first dielectric 10a and the second dielectric 10b are formed as described above, the range where the return loss is approximately less than or equal to −10 dB spreads from 2.7 GHz towards higher frequency.

Further the return loss around 10 GHz is about −9 dB and it can be judged that the preferable antenna characteristic is obtained.

Therefore, the antenna device has an operation frequency band which spreads from 2.8 GHz towards higher frequency which is the preferable characteristic, and a wider band characteristic compared with the cases where the dielectric 10 is not provided.

The deterioration of the characteristic at the middle wide band from 6 GHz to 9 GHz which is the problem in case where the dielectric 10 is formed entirely on the both surfaces is improved by the resonances around 7.2 GHz and 8.5 GHz.

### Thirty-Third Embodiment

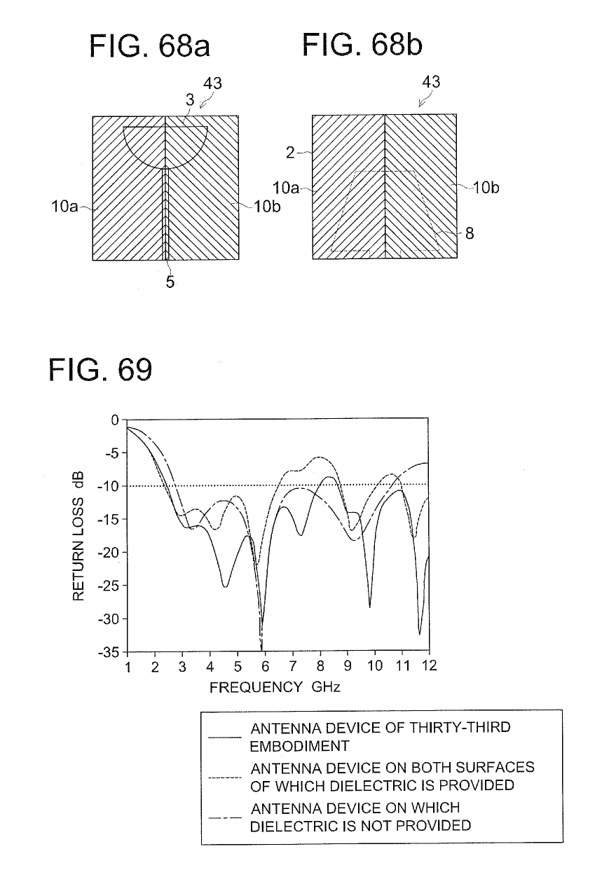

As illustrated in FIG. 68, the first dielectric 10a is formed entirely at the left half section in respect to the centerline on the first surface of the supporting board 2 and the second dielectric 10b is formed entirely at the right half section in respect to the centerline on the first surface of the supporting board 2.

Further on the second surface of the supporting board 2, the first dielectric 10a and the second dielectric 10b are formed so as to overlap respectively the first dielectric 10a and the second dielectric 10b formed on the first surface.

The antenna characteristic of the antenna device 43 is shown in FIG. 69.

As shown in FIG. 69, in case where the first dielectric 10a and the second dielectric 10b are formed as described above, the range where the return loss is less than and equal to −10 dB spreads from 2.4 GHz to 8.0 GHz and from 8.6 GHz towards higher frequency. Further the return loss around 8.3 GHz is about −8 dB and the preferable value is obtained.

Therefore, the antenna device has the operation frequency band which spreads from 2.4 GHz towards higher frequency and the preferable characteristic. Further, the deterioration of the characteristic at the middle wide band from 6 GHz to 9 GHz which is the problem in case where the dielectric 10 is formed entirely on the both surfaces is improved by the resonance around 7.3 GHz. Further the minimum frequency of the return loss of −10 dB is 2.4 GHz, goes down as same as the case where the dielectric 10 is adhered entirely to the both surfaces and it can be judged that this case is effective also for miniaturizing the antenna device compared with the case where the dielectric 10 is not provided.

### Thirty-Fourth Embodiment

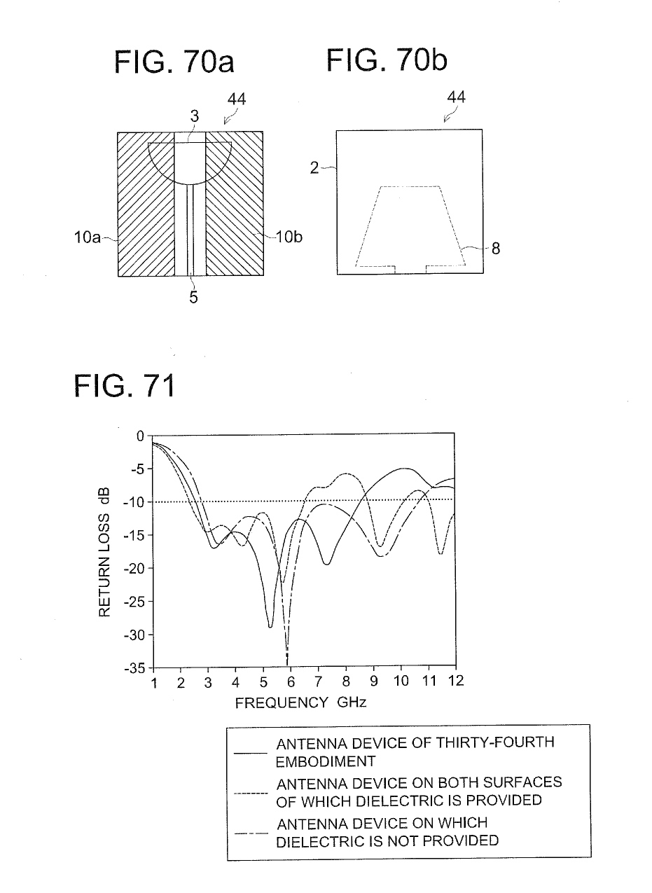

As illustrated in FIG. 70, the first dielectric 10a is formed at the left half section in respect to the centerline on the first surface of the supporting board 2 so as to avoid the transmission line 5 and the matching section 9, and the second dielectric 10b is formed at the right half section in respect to the centerline on the first surface of the supporting board 2 so as to avoid the transmission line 5 and the matching section 9.

The antenna characteristic of the antenna device 44 is shown in FIG. 71.

As shown in FIG. 71, in case where the first dielectric 10a and the second dielectric 10b are formed as described above, the range where the return loss is less than and equal to −10 dB spreads from 2.4 GHz to 8.6 GHz. Although the frequency band itself is narrower than the case where the dielectric 10 is not provided, better characteristic is obtained at the range from 2.5 GHz to 5.5 GHz, compared with the case where the dielectric 10 is not provided.

Further, the deterioration of the characteristic at the middle wide band from 6 GHz to 9 GHz which is the problem in case where the dielectric 10 is formed entirely on the both surfaces is improved by the resonance around 7.3 GHz.

Further, as previously described, the range from 3.1 GHz to 4.8 GHz is up for the frequency band used for a wireless USB. In the antenna device 44 of the present embodiment, the return loss at the ranges from 3.1 GHz to 4.8 GHz is less than or equal to −15 dB and the antenna device 44 of the present embodiment is realized as the antenna device suitable for the wireless USB application.

Further the minimum frequency of the return loss of −10 dB is 2.5 GHz, goes down as same as the case where the dielectric 10 is adhered entirely to the both surfaces and it can be judged that this case is effective also for miniaturizing the antenna device compared with the case where the dielectric 10 is not provided.

### Thirty-Fifth Embodiment

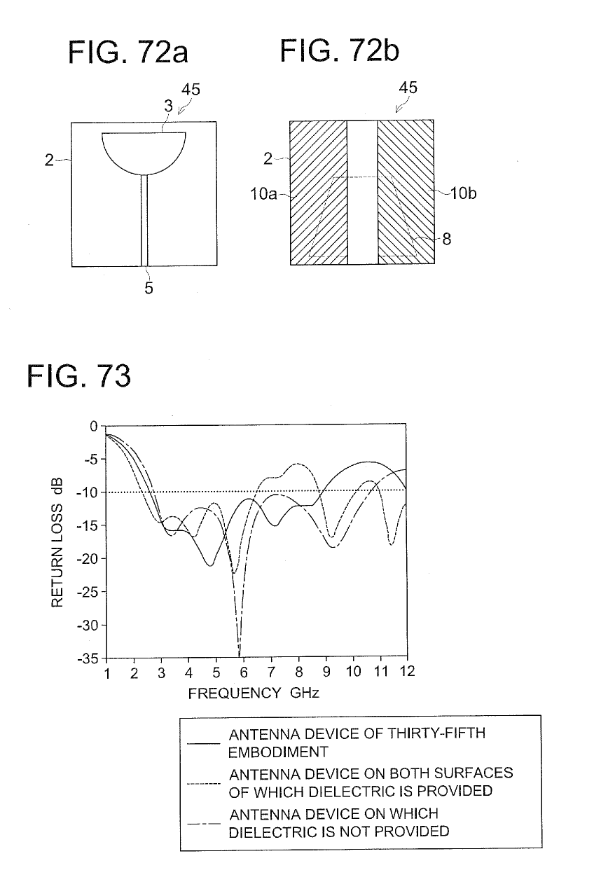

As illustrated in FIG. 72, the first dielectric 10a is formed at the left half section in respect to the centerline on the second surface of the supporting board 2 so as to avoid the transmission line 5 and the matching section 9, and the second dielectric 10b is formed at the right half section in respect to the centerline on the second surface of the supporting board 2 so as to avoid the transmission line 5 and the matching section 9.

The antenna characteristic of the antenna device 45 is shown in FIG. 73.

As shown in FIG. 73, in case where the first dielectric 10a and the second dielectric 10b are formed as described above, the range where the return loss is less than and equal to −10 dB spreads from 2.5 GHz to 8.9 GHz. Although the frequency band itself is narrower than the case where the dielectric 10 is not provided, better characteristic is obtained at the range from 2.5 GHz to 5.4 GHz, compared with the case where the dielectric 10 is not provided.

Further, the deterioration of the characteristic at the middle wide band from 6 GHz to 9 GHz which is the problem in case where the dielectric 10 is formed entirely on the both surfaces is improved by the resonance around 7.1 GHz.

Further, as previously described, the range from 3.1 GHz to 4.8 GHz is up for the frequency band used for the wireless USE. In the antenna device 45 of the present embodiment, the return loss at the ranges from 3.1 GHz to 4.8 GHz is less than or equal to −16 dB and the antenna device 45 of the present embodiment is realized as the antenna device suitable for the wireless USB application.

Further the minimum frequency where the return loss is −10 dB is 2.5 GHz, goes down as same as the case where the dielectric 10 is adhered entirely to the both surfaces and it can be judged that this case is effective also for miniaturizing the antenna device compared with the case where the dielectric 10 is not provided.

### Thirty-Sixth Embodiment

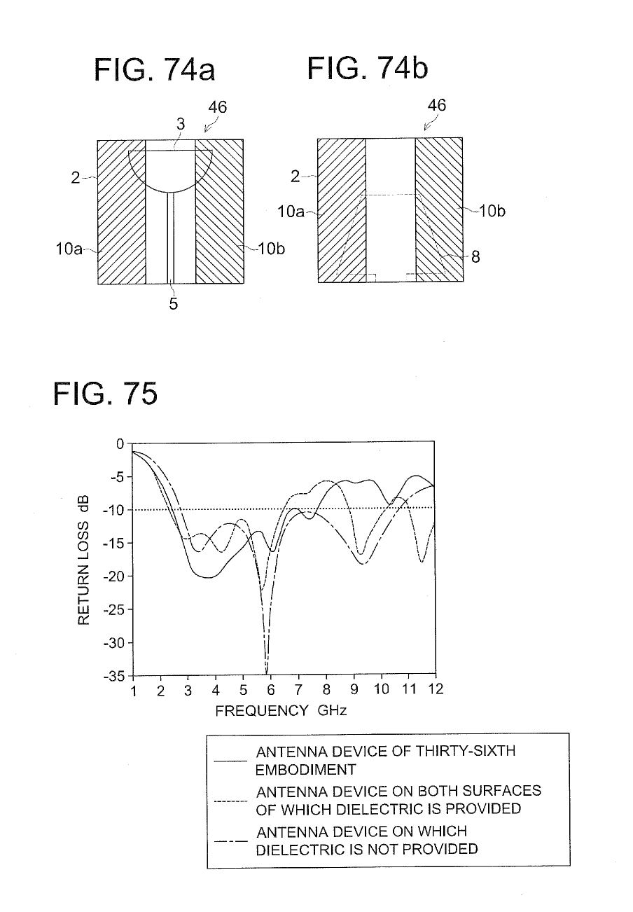

As illustrated in FIG. 74, the first dielectric 10a is formed at the left half section in respect to the centerline on the first surface of the supporting board 2 so as to avoid the transmission line 5 and the matching section 9, and the second dielectric 10b is formed at the right half section in respect to the centerline on the first surface of the supporting board 2 so as to avoid the transmission line 5 and the matching section 9. Further on the second surface of the supporting board 2, the dielectric 10 is formed so as to overlap the dielectric 10 formed on the first surface.

The antenna characteristic of the antenna device 46 is shown in FIG. 75.

As shown in FIG. 75, in case where the first dielectric 10a and the second dielectric 10b are formed as described above, the range where the return loss is less than and equal to −10 dB spreads from 2.4 GHz to 7.7, further better characteristic compared with the case where the dielectric is not provided is obtained from 5.2 GHz towards lower frequency.

Further, the deterioration of the characteristic at the middle wide band from 6 GHz to 9 GHz which is the problem in case where the dielectric 10 is formed entirely on the both surfaces is improved by the resonance around 7.5 GHz.

Further, as previously described, the range from 3.1 GHz to 4.8 GHz is up for the frequency band used for the wireless USB. In the antenna device 45 of the present embodiment, the return loss at the ranges from 3.1 GHz to 4.8 GHz is less than or equal to −17 dB and the antenna device 45 of the present embodiment is realized as the antenna device suitable for the wireless USB application.

Further the minimum frequency where the return loss is −10 dB is 2.5 GHz, goes down as same as the case where the dielectric 10 is adhered entirely to the both surfaces and it can be judged that this case is effective also for miniaturizing the antenna device compared with the case where the dielectric 10 is not provided.

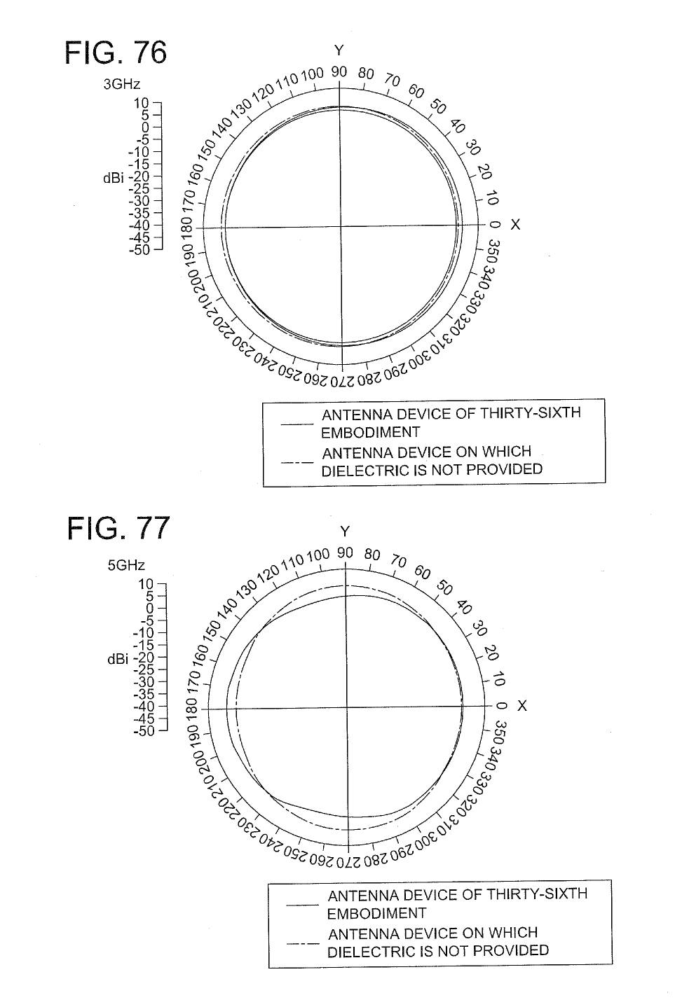

A radiating pattern of 3 GHz in a horizontal plane (XY plane) of the antenna device 46 is shown in the FIG. 76, and a radiating pattern of 5 GHz is shown in FIG. 77.

As comparative examples, radiating patterns of the antenna devices on which the dielectric is not provided are shown by dashed line in FIGS. 76 and 77.

As shown in FIGS. 76 and 77, when the cases where the first dielectric 10a and the second dielectric 10b are provided on the antenna device 46 and the cases where the dielectric is not provided are compared, although there is a small change in the radiating patterns, a large change is not observed and it can be judged that they are almost identical. Therefore forming the dielectric has little influences to the radiating characteristic and good radiating characteristic (direction characteristic) can be obtained.

Further, in the antenna devices relating to the embodiments through the first embodiment and thirty-sixth embodiment, so called half circle-trapezoidal unbalanced dipole antennas combining the first radiating plate 3 having an arc shape in planar view and the second radiating plate 8 having an approximately trapezoidal shape in planar view provided on the both surfaces of the supporting board 2 are used and explained. However, if two radiating plates having different shapes are combined to make a pair of radiating plates, there are no particular limitations to the combinations and shapes of the radiating plates, for example, a flat type small volcano smoke antenna and so on can be used.

And further, in the antenna devices relating to the embodiments through the first embodiment and thirty-sixth embodiment, as the methods of forming the dielectric 10, the first dielectric 10a and the second dielectric 10b, the combinations described above are just examples, are not limited to the forming positions, and are arbitrarily set in accordance with necessities.

1. An antenna device comprising:
a supporting board;
a planar first radiating plate formed on a first surface of the supporting board and having an electric feeding point;
a transmission line electrically connected to the electric feeding point formed on the first surface and extending up to one side of the supporting board; and
a planar second radiating plate formed on a second surface of the supporting board,
wherein each of the first radiating plate and the second radiating plate is formed in line symmetry with respect to a centerline of the transmission line and/or an extended line of the centerline when viewed in a thickness direction of the support board, and a dielectric is formed in one of two regions located on mutually opposite sides of the center line of the transmission line and the extended line of the center line when viewed in the thickness direction of the support board, on at least one of the first surface and the second surface.

2. An antenna device comprising:
a supporting board;
a planar first radiating plate having an electric feeding point formed on a first surface of the supporting board;
a transmission line electrically connected to the electric feeding point formed on the first surface and extending up to one side of the supporting board; and
a planar second radiating plate formed on a second surface of the supporting board,
wherein each of the first radiating plate and the second radiating plate is formed in line symmetry with respect to a centerline of the transmission line and/or an extended line of the centerline when viewed in a thickness direction of the support board;
a dielectric is formed respectively at both of two regions located on mutually opposite sides of the center line of the transmission line and the extended line of the center line when viewed in the thickness direction of the support board, on at least one of the first surface and the second surface; and
a dielectric constant of each region is different from each other.

3. The antenna device described in claim 1, wherein the first radiating plate is formed in a semicircular shape such a manner that an outer border of a side of the electric feeding point expands in an arc form toward the one side; and
the second radiating plate is formed in an approximately trapezoidal shape, upper base of which locates on an opposite side to the electric feeding point, at a position where the second radiating plate does not overlap with the first radiating plate when viewed in the thickness direction of the supporting plate.

4. The antenna device described in claim 1, wherein the dielectric is formed so as to cover at least a part of an edge of the radiating plate.

5. The antenna device described in claim 1, wherein the dielectric is formed at a part which does not overlap the electric feeding point when viewed in the thickness direction of the supporting plate.

6. The antenna device described in claim 2, wherein the first radiating plate is formed in a semicircular shape such a manner that an outer border of a side of the electric feeding point expands in an arc form toward the one side; and
the second radiating plate is formed in an approximately trapezoidal shape, upper base of which locates on an opposite side to the electric feeding point, at a position where the second radiating plate does not overlap with the first radiating plate when viewed in the thickness direction of the supporting plate.

7. The antenna device described in claim 2, wherein the dielectric is formed so as to cover at least a part of an edge of the radiating plate.

8. The antenna device described in claim 1, wherein the dielectric is formed so as to avoid a part which overlaps the electric feeding point when viewed in the thickness direction of the supporting plate.

9. The antenna device described in claim 2, wherein the dielectric is formed so as to avoid a part which overlaps the electric feeding point when viewed in the thickness direction of the supporting plate.
